(19) United States
(12) Patent Application Publication
(10) Pub. No.: US 2026/0122247 A1
(43) Pub. Date: Apr. 30, 2026

(54) DECODING METHOD, ENCODING METHOD, AND STORAGE MEDIUM

(71) Applicant: GUANGDONG OPPO MOBILE TELECOMMUNICATIONS CORP., LTD., Dongguan (CN)

(72) Inventor: Zhihuang XIE, Dongguan (CN)

(21) Appl. No.: 19/433,518

(22) Filed: Dec. 26, 2025

Related U.S. Application Data
(63) Continuation of application No. PCT/CN2023/103395, filed on Jun. 28, 2023.

(51) Int. Cl. H04N 19/147; H04N 19/105; H04N 19/176; H04N 19/196; H04N 19/593

(52) U.S. Cl. CPC H04N 19/147; H04N 19/105; H04N 19/176; H04N 19/196; H04N 19/593

(57) ABSTRACT

A decoding method, an encoding method, and a storage medium are provided in the disclosure. The decoding method includes the following. Determine that an intra block copy local illuminance compensation (IBC-LIC) mode is used for a current block. A first prediction mode used for the current block in the IBC-LIC mode is determined. Illuminance compensation is performed, based on a model corresponding to the first prediction mode, on a first prediction block of the current block to obtain a second prediction block of the current block, where the first prediction block is an intra block copy (IBC) prediction block.

### CROSS REFERENCE TO RELATED APPLICATION(S)

This application is a continuation of International Application No. PCT/CN2023/103395, filed Jun. 28, 2023, the entire disclosure of which is incorporated herein by reference.

### TECHNICAL FIELD

This disclosure relates to the field of coding technologies, and more specifically to a decoding method, an encoding method, and a storage medium.

### BACKGROUND

Digital video compression technology mainly involves compressing a huge amount of digital picture video data, so as to facilitate transmission, storage, or the like.

With the surge of internet video and higher requirements for video clarity, although a lot of video data can be saved with existing digital video compression standards, at present, there is still a need for better digital video compression technology to reduce pressure on a bandwidth and a traffic of digital video transmission.

### SUMMARY

In a first aspect, a decoding method is provided in the disclosure. The method includes the following. Determine that an intra block copy local illuminance compensation (IBC-LIC) mode is used for a current block. A first prediction mode used for the current block in the IBC-LIC mode is determined. Illuminance compensation is performed, based on a model corresponding to the first prediction mode, on a first prediction block of the current block to obtain a second prediction block of the current block, where the first prediction block is an intra block copy (IBC) prediction block.

In a second aspect, an encoding method is provided in the disclosure. The method includes the following. Determine that an intra block copy local illuminance compensation (IBC-LIC) mode is used for a current block. A first prediction mode used for the current block in the IBC-LIC mode is determined. Illuminance compensation is performed, based on a model corresponding to the first prediction mode, on a first prediction block of the current block to obtain a second prediction block of the current block, where the first prediction block is an intra block copy (IBC) prediction block.

In a third aspect, a non-transitory computer-readable storage medium is provided. The storage medium stores computer programs and a bitstream. When executed by a processor, the computer programs cause the processor to perform the encoding method in the second aspect to generate the bitstream.

### BRIEF DESCRIPTION OF THE DRAWINGS

FIG. 1 is a schematic block diagram of a video coding system provided in the disclosure.

FIG. 2 is a schematic block diagram of a video encoder provided in the disclosure.

FIG. 3 is a schematic structural diagram illustrating a relationship between a coding tree unit (CTU) and a coding unit (CU) provided in the disclosure.

FIG. 4 is a schematic block diagram of a video decoder provided in the disclosure.

FIG. 5 is an example of pictures with different luma and substantially the same texture provided in the disclosure.

FIG. 6 is an example of a modeled relationship between a reference picture and a current picture provided in the disclosure.

FIG. 7 is an example of partitioning of a CTU and a CU provided in the disclosure.

FIG. 8 is an example of intra block copy (IBC) provided in the disclosure.

FIG. 9 is an example of pictures with similar texture provided in the disclosure.

FIG. 10 is a schematic flowchart of a decoding method provided in the disclosure.

FIG. 11 is an example of template regions provided in the disclosure.

FIG. 12 is a schematic flowchart of an encoding method provided in the disclosure.

FIG. 13 is a schematic block diagram of a decoder provided in the disclosure.

FIG. 14 is a schematic block diagram of an encoder provided in the disclosure.

FIG. 15 is a schematic structural diagram of an electronic device provided in the disclosure.

### DETAILED DESCRIPTION

Solutions provided in the disclosure are applicable to the field of digital compression technology.

Digital video compression technology mainly involves compressing a huge amount of digital picture video data, so as to facilitate transmission, storage, or the like.

Solutions provided in the disclosure are applicable to the field of digital video coding technology.

The field of digital video coding technology includes, but is not limited to, at least one of: picture coding, video coding, hardware video coding, dedicated circuit video coding, real-time video coding, or the like. In addition, the solutions provided in the disclosure can be incorporated into audio video coding standards (AVS), AVS 2, or AVS 3. For example, the AVS includes, but is not limited to, H.264/audio video coding (AVC) standard, H.265/high efficiency video coding (HEVC) standard, and H.266/versatile video coding (VVC) standard. Furthermore, the solutions provided in the disclosure can be used for performing lossy compression or lossless compression on a picture. The lossless compression may be visually lossless compression or mathematically lossless compression.

A block-based hybrid coding framework can be used in video coding standards.

The hybrid coding framework includes modules such as prediction, transform, quantization, entropy coding, and in-loop filter. The prediction module includes intra prediction and/or inter prediction. Since there is a strong correlation between neighbouring samples in a video picture, intra prediction is used in the video coding technology to eliminate spatial redundancy between neighbouring samples. In intra prediction, reference can be made to only picture information of the same picture to predict sample information of a current partition block. Moreover, since there is also a strong similarity between neighbouring pictures in video, inter prediction is used in the video coding technology to eliminate temporal redundancy between neighbouring pictures, thereby improving coding efficiency. The inter prediction includes motion estimation and motion compensation. In inter prediction, reference can be made to picture information of different pictures, and motion estimation is used to search for motion vector (MV) information that best matches the current partition block. For the transform, a predicted block is transformed into a frequency domain, redistributing energy. Combined with the quantization, information that is not sensitive to human eyes is removed, thereby eliminating visual redundancy. The entropy coding can eliminate character redundancy according to a current context model and probability information of a binary bitstream.

A basic process performed by a video encoder is as follows. The encoder first partitions a picture into blocks, and then obtains a prediction block of a current block by predicting the current block in a current picture. Next, the encoder obtains a residual block by subtracting the prediction block from an original block of the current block. The encoder obtains a quantization coefficient matrix by performing transform and quantization on the residual block, and then obtains an output bitstream by entropy coding the quantization coefficient matrix.

A basic process performed by a video decoder is as follows. For one thing, the decoder obtains a prediction block of a current block by predicting the current block. For another, the decoder obtains a quantization coefficient matrix by parsing a bitstream, and obtains a residual block by performing inverse quantization and inverse transform on the quantization coefficient matrix. Then, the decoder obtains a reconstructed block by adding the prediction block and the residual block. The reconstructed blocks form a reconstructed picture, and a decoded picture is obtained by performing in-loop filtering on the reconstructed picture on a picture basis or on a block basis.

It may be noted that, the current block may be a current coding unit (CU) or a current prediction unit (PU), etc.

In addition, the encoder also requires similar operations as the decoder to obtain the decoded picture. The decoded picture can be used as a reference picture of a subsequent picture for inter prediction. Block partition information determined by the encoder, as well as mode information or parameter information for prediction, transformation, quantization, entropy coding, in-loop filtering, etc., are signalled into the bitstream when necessary. The decoder parses the bitstream and analyzes existing information to determine the block partition information, as well as the mode information or the parameter information for prediction, transformation, quantization, entropy coding, in-loop filtering, etc. the same as such information at the encoder, so as to ensure that the decoded picture obtained by the encoder is the same as the decoded picture obtained by the decoder. The decoded picture obtained by the encoder is also usually referred to as “reconstructed picture”. A codec may partition the current block into PUs during prediction, and partition the current block into transform units (TUs) during transform. The partition of the PUs may be different from the partition of the TUs. The above is the basic process of the video codec under the block-based hybrid coding framework. With the development of technology, some modules or operations of the framework or process may be optimized. This disclosure is not limited in this regard.

It may be noted that, terms used in the implementations of the disclosure are merely intended for explaining embodiments of the disclosure rather than limiting the disclosure.

For example, the term “and/or” herein only describes an association relationship between associated objects, and indicates that there may be three relationships, for instance, A and/or B may mean A alone, both A and B exist, and B alone. The term “at least one” only describes a combination relationship between listed objects, and indicates one or more, for instance, at least one of A, B, or C may mean A alone, B alone, C alone, both A and B exist, both A and C exist, both B and C exist, and A, B, and C all exist. The term “a plurality of” or “multiple” refers to two or more. The character “/” generally indicates that the associated objects are in an “or” relationship.

For another example, the term “correspondence” may mean that there is a direct or indirect correspondence between the two, may mean that there is an association relationship between the two, or may mean a relationship of indicating and being indicated or configuring and being configured, etc. The term “indication” may be a direct indication, may be an indirect indication, or may mean that there is an association relationship. As an example, A indicates B may mean that A directly indicates B, for instance, B can be obtained according to A; may mean that A indirectly indicates B, for instance, A indicates C, and B can be obtained according to C; or may mean that that there is an association relationship between A and B. The term “pre-defined” or “pre-configured” may be implemented by pre-storing a corresponding code(s) or a corresponding table(s) in a device (for example, including the encoder and the decoder) or in other manners that can be used for indicating related information, or may mean defined in a protocol. The “protocol” may refer to any standard protocol in the coding field, and this disclosure is not limited in this regard. The term “when” may be interpreted as “if” or “on condition that” or “at the time when . . . ” or “in response to”, etc. Similarly, the phrase “if it is determined that” or “if (the condition or event stated) is detected” may be interpreted as “upon determining” or “in response to determining” or “upon detecting (the condition or event stated)” or “in response to detecting (the condition or event stated)”, etc., depending on the context. The terms “first”, “second”, “third”, “fourth”, “A-th” “B-th”, and the like are used to distinguish different objects rather than describe a particular order. The terms “include”, “comprise”, and “have” as well as variations thereof are intended to cover non-exclusive inclusion.

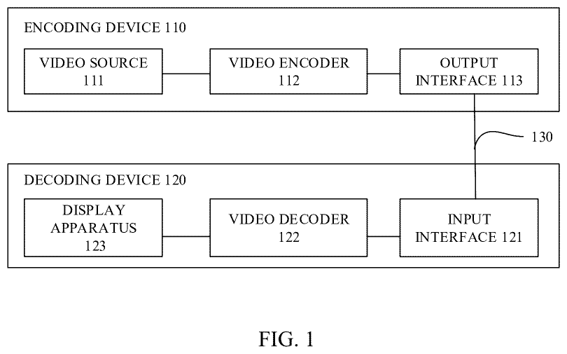

For ease of understanding, a video coding system in embodiments of the disclosure is first introduced with reference to FIG. 1.

FIG. 1 is a schematic block diagram of a video coding system in embodiments of the disclosure.

As illustrated in FIG. 1, the video coding system 100 includes an encoding device 110 and a decoding device 120.

The encoding device 110 is configured to encode (which can be understood as compress) video data to generate a bitstream, and transmit the bitstream to the decoding device 120. The decoding device 120 is configured to decode the bitstream generated by the encoding device 110 to obtain decoded video data.

The encoding device 110 can be understood as a device having a video encoding function, and the decoding device 120 can be understood as a device having a video decoding function, that is, the encoding device 110 and the decoding device 120 in embodiments of the disclosure include a wider range of devices, including smartphones, desktop computers, mobile computing devices, notebook (such as laptop) computers, tablet computers, set-top boxes, televisions, cameras, display apparatuses, digital media players, video game consoles, vehicle-mounted computers, and the like.

The encoding device 110 may transmit encoded video data (such as a bitstream) to the decoding device 120 via a channel 130.

The channel 130 may include one or more media and/or apparatuses capable of transmitting the encoded video data from the encoding device 110 to the decoding device 120.

The channel 130 may include one or more communication media that enable the encoding device 110 to transmit the encoded video data directly to the decoding device 120 in real-time. The encoding device 110 may modulate the encoded video data according to a communication standard and transmit the modulated video data to the decoding device 120. The communication medium includes a wireless communication medium, such as a radio frequency spectrum. The communication medium may also include a wired communication medium, such as one or more physical transmission lines.

The channel 130 may include a storage medium that can store video data encoded by the encoding device 110. The storage medium includes a variety of local access data storage media, such as optical discs, digital video discs (DVDs), flash memory, and the like. In this example, the decoding device 120 may obtain encoded video data from the storage medium.

The channel 130 may include a storage server that may store video data encoded by the encoding device 110. In this example, the decoding device 120 may download the stored encoded video data from the storage server. Optionally, the storage server may store the encoded video data and may transmit the encoded video data to the decoding device 120. For example, the storage server may be a web server (e.g., for a website), a file transfer protocol (FTP) server, and the like.

The encoding device 110 includes a video encoder 112 and an output interface 113.

The output interface 113 may include a modulator/demodulator (modem) and/or a transmitter. The video encoder 112 directly transmits the encoded video data to the decoding device 120 via the output interface 113. The encoded video data can also be stored on a storage medium or a storage server for subsequent reading by the decoding device 120.

The encoding device 110 may include a video source 111 in addition to the video encoder 112 and the input interface 113.

The video source 111 may include at least one of a video capture apparatus (for example, a video camera), a video archive, a video input interface, or a computer graphics system, where the video input interface is configured to receive video data from a video content provider, and the computer graphics system is configured to generate video data. The video encoder 112 is configured to encode the video data from the video source 111 to generate a bitstream. The video data may include one or more pictures or a sequence of pictures. The bitstream contains encoding information of a picture or a sequence of pictures. The encoding information may include encoded picture data and associated data. The associated data may include a sequence parameter set (SPS), a picture parameter set (PPS), and other syntax structures. The SPS may contain parameters applied to one or more sequences. The PPS may contain parameters applied to one or more pictures. The syntax structure refers to a set of zero or multiple syntax elements arranged in a specified order in the bitstream.

The decoding device 120 includes an input interface 121 and a video decoder 122. The input interface 121 may include a receiver and/or a modem.

The decoding device 120 may include a display apparatus 123 in addition to the input interface 121 and the video decoder 122.

The input interface 121 may receive encoded video data through the channel 130. The video decoder 122 is configured to decode the encoded video data to obtain decoded video data, and transmit the decoded video data to the display apparatus 123. The display apparatus 123 is configured to display the decoded video data. The display apparatus 123 may be integrated with the decoding device 120 or external to the decoding device 120. The display apparatus 123 may include various display apparatuses, such as a liquid crystal display (LCD), a plasma display, an organic light emitting diode (OLED) display, or other types of display apparatuses.

It may be understood that, FIG. 1 is only an example of the disclosure, which may not be construed as a limitation to the disclosure. That is to say, the technical solutions of embodiments of the disclosure are not limited to the system framework illustrated in FIG. 1. For example, the technology of the disclosure may also be applied to single-side video encoding or single-side video decoding.

A video encoding framework in embodiments of the disclosure will be introduced below.

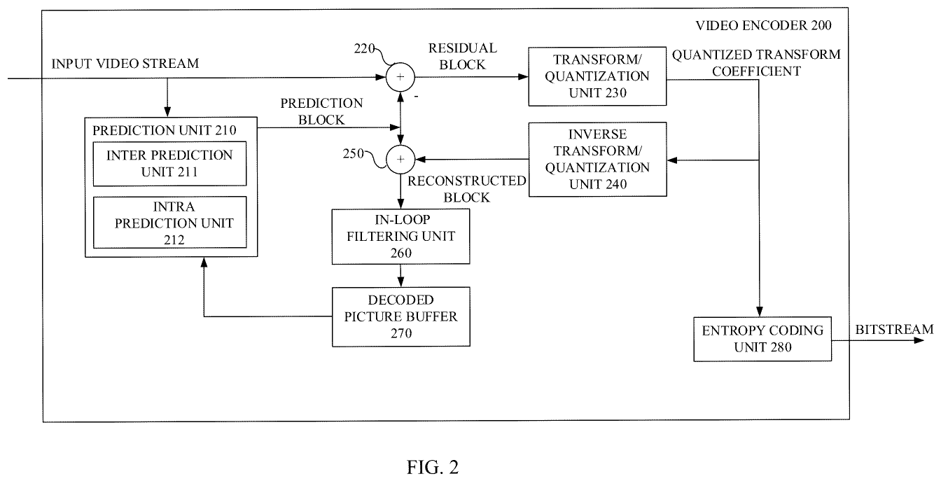

FIG. 2 is a schematic block diagram of a video encoder 200 in embodiments of the disclosure.

It may be understood that, the video encoder 200 may be applied to picture data in luma-chroma (YCbCr, YUV) format. For example, a YUV ratio may be 4:2:0, 4:2:2, or 4:4:4, where Y represents luminance (Luma), Cb (U) represents blue chrominance, and Cr (V) represents red chrominance. U and V represent chrominance (Chroma) for describing colour and saturation. For example, in terms of colour format, 4:2:0 represents that every 4 pixels have 4 luma components and 2 chroma components (YYYYCbCr), 4:2:2 represents that every 4 pixels have 4 luma components and 4 chroma components (YYYYCbCrCbCr), and 4:4:4 represents full pixel display (YYYYCbCrCbCrCbCrCbCr). Certainly, the video encoder 200 may also be applied to picture data in red-green-blue (RGB) format, and this disclosure is not limited in this regard.

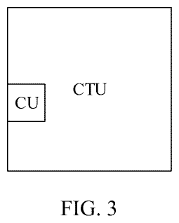

After reading a video stream, for each picture in the video stream, the video encoder 200 may partition the picture into several coding tree units (CTUs). In some examples, the CTU may be called “tree block”, “largest coding unit” (LCU), or “coding tree block” (CTB). Each CTU may be associated with a sample block of the same size as the CTU within the picture. Each sample may correspond to one luminance (luma) sample and two chrominance (chroma) samples. Thus, each CTU may be associated with one luma sample block and two chroma sample blocks. The CTU may have a size of 128×128, 64×64, 32×32, and so on. FIG. 3 is a schematic structural diagram illustrating a relationship between a CTU and a CU provided in the disclosure. As illustrated in FIG. 3, the CTU may be further partitioned into several CUs for coding. The CU may be a rectangular block or a square block. The CU may be further partitioned into a PU and a TU, so that coding, prediction, and transformation are separated, and thus processing is more flexible. In an example, the CTU is partitioned into CUs in a tree (e.g., quadtree) manner, and the CU is partitioned into TUs and PUs in a tree (e.g., quadtree) manner.

The video encoder and the video decoder can support various PU sizes.

Assuming that a size of a specific CU is 2N×2N, the video encoder and video decoder can support PUs of 2N×2N or N×N for intra prediction, and support symmetric PUs of 2N×2N, 2N×N, N×2N, N×N, or similar size for inter prediction. The video encoder and video decoder can also support asymmetric PUs of 2N×nU, 2N×nD, nL×2N, or nR×2N for inter prediction.

As illustrated in FIG. 2, the video encoder 200 may include a prediction unit 210, a residual unit 220, a transform/quantization unit 230, an inverse transform/quantization unit 240, a reconstruction unit 250, an in-loop filtering unit 260, a decoded picture buffer 270, and an entropy coding unit 280. It may be noted that, the video encoder 200 may include more, less, or different functional components. In the disclosure, a current block may be referred to as a current CU or a current PU, etc. A prediction block may be referred to as a prediction picture block or a picture prediction block, and a reconstructed picture block may be referred to as a reconstructed block or a picture reconstructed block.

The prediction unit 210 includes an inter prediction unit 211 and an intra prediction unit 212. Since there is a strong correlation between neighbouring samples in a video picture, intra prediction is used in the video coding technology to eliminate spatial redundancy between neighbouring samples. Since there is a strong similarity between neighbouring pictures in video, inter prediction is used to eliminate temporal redundancy between neighbouring pictures, thereby improving coding efficiency.

The inter prediction unit 211 can be used for inter prediction. The inter prediction may include motion estimation and motion compensation. In inter prediction, reference can be made to picture information of different pictures. In inter prediction, motion information is used to find a reference block from a reference picture, and a prediction block is generated according to the reference block to eliminate temporal redundancy. The reference picture may be a P picture and/or a B picture, where P picture refers to a forward prediction picture, and B picture refers to a bidirectional prediction picture. In inter prediction, after motion information is used to find a reference block, a prediction block is generated according to the reference block. The motion information includes a picture list to which the reference picture belongs, a picture index, and an MV. The MV may be an integer-sample MV or a fractional-sample MV. If the MV is the fractional-sample MV, interpolation filtering on the reference picture is required to generate a required fractional-sample block. The reference block refers to an integer-sample block or fractional-sample block found according to the MV. In some technologies, the reference block may be called a prediction block, and in some technologies, the prediction block will be generated based on the reference block. Generating the prediction block based on the reference block can also be understood as taking the reference block as a prediction block and then processing to generate a new prediction block based on the prediction block.

The intra prediction unit 212 is configured to predict sample information of the current block only with reference to information of the same picture, so as to eliminate spatial redundancy. A reference picture for which intra prediction is used may be an I picture.

There are multiple prediction modes for intra prediction. In intra prediction, an angular prediction mode and a non-angular prediction mode can be used to predict a block to-be-encoded, so as to obtain a prediction block. An optimal prediction mode for the block to-be-encoded is selected according to rate-distortion information calculated based on the prediction block and the block to-be-encoded, and the prediction mode is signalled into a bitstream and transmitted to the decoding end. The decoding end parses out the prediction mode, obtains a prediction block of a target decoding block through prediction, and then obtains a reconstructed block by adding the prediction block and a time-domain residual block obtained based on the bitstream.

Taking international digital video coding standard H series as an example, H.264/AVC standard includes eight angular prediction modes and one non-angular prediction mode, and H.265/HEVC is extended to include 33 angular prediction modes and two non-angular prediction modes. Intra prediction modes used in HEVC include a planar mode, a direct current (DC) mode, and 33 angular modes, with a total of 35 prediction modes. Intra modes used in VVC include a planar mode, a DC mode, and 65 angular modes, with a total of 67 prediction modes, which include traditional prediction modes and non-traditional prediction modes. The non-traditional prediction mode may include a matrix weighted intra prediction (MIP) mode. The traditional prediction modes include a planar mode with mode number 0, a DC mode with mode number 1, and angular prediction modes with mode number 2 to mode number 66. It may be noted that with an increase in the number (quantity) of angular modes, intra prediction will be more accurate, which will be more in line with the demand for the development of high-definition and ultra-high-definition digital video.

The residual unit 220 may generate a residual block of the CU based on a sample block of the CU and a prediction block of a PU of the CU. For example, the residual unit 220 may generate the residual block of the CU such that each sample in the residual block has a value equal to a difference between a sample in the sample block of the CU and a corresponding sample in the prediction block of the PU of the CU.

The transform/quantization unit 230 may quantize a transform coefficient. The transform/quantization unit 230 may quantize a transform coefficient associated with a TU of a CU based on a quantization parameter (QP) value associated with the CU. The video encoder 200 may adjust the degree of quantization applied to a transform coefficient associated with the CU by adjusting the QP value associated with the CU.

The inverse transform/quantization unit 240 may perform inverse quantization and inverse transform respectively on the quantized transform coefficient, to reconstruct a residual block from the quantized transform coefficient.

The reconstruction unit 250 may add samples in the reconstructed residual block to corresponding samples in one or more prediction blocks generated by the prediction unit 210, to generate a reconstructed picture block associated with the TU. By reconstructing sample blocks of each TU of the CU in this way, the video encoder 200 can reconstruct the sample block of the CU.

The in-loop filtering unit 260 is configured to process an inverse-transformed and inverse-quantized sample, compensate distorted information, and provide a better reference for subsequent sample encoding. For example, the in-loop filtering unit 260 can perform deblocking filtering operations to reduce blocking artifacts of the sample block associated with the CU. In some embodiments, the in-loop filtering unit 260 includes a deblocking filtering (DBF) unit and a sample adaptive offset/adaptive loop filtering (SAO/ALF) unit, where the DBF unit is configured for deblocking, and the SAO/ALF unit is configured to remove a ringing effect.

The decoded picture buffer 270 may store reconstructed sample blocks.

The inter prediction unit 211 may use reference pictures containing reconstructed sample blocks in the decoded picture buffer 270 to perform inter prediction on PUs of other pictures. In addition, the intra prediction unit 212 may use the reconstructed sample blocks in the decoded picture buffer 270 to perform intra prediction on other PUs in the same picture as the CU.

The entropy coding unit 280 may receive the quantized transform coefficient from the transform/quantization unit 230. The entropy coding unit 280 may perform one or more entropy coding operations on the quantized transform coefficient to generate entropy-coded data.

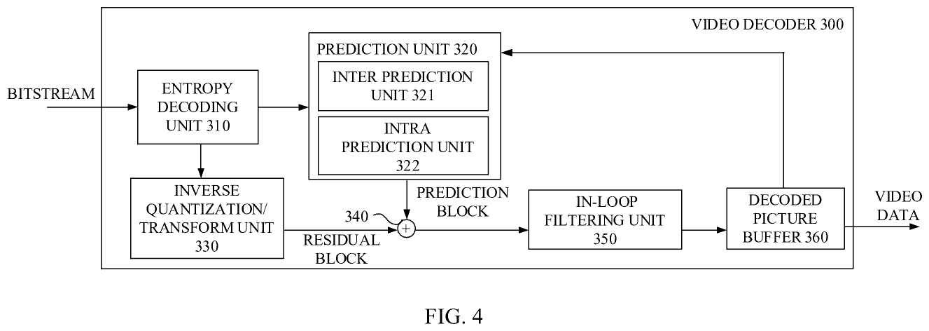

FIG. 4 is a schematic block diagram of a video decoder in embodiments of the disclosure.

As illustrated in FIG. 4, the video decoder 300 includes an entropy decoding unit 310, a prediction unit 320, an inverse quantization/transform unit 330, a reconstruction unit 340, an in-loop filtering unit 350, and a decoded picture buffer 360. It may be noted that, the video decoder 300 may include more, less, or different functional components.

The video decoder 300 may receive a bitstream. The entropy decoding unit 310 may parse the bitstream to extract syntax elements from the bitstream. As part of parsing the bitstream, the entropy decoding unit 310 may parse entropy-coded syntax elements in the bitstream. The prediction unit 320, the inverse quantization/transform unit 330, the reconstruction unit 340, and the in-loop filtering unit 350 may decode video data according to the syntax elements extracted from the bitstream, that is, generate decoded video data.

The prediction unit 320 includes an intra prediction unit 322 and an inter prediction unit 321.

The intra prediction unit 322 may perform intra prediction to generate a prediction block of a PU. The intra prediction unit 322 may use an intra prediction mode to generate a prediction block of the PU based on a sample block of spatially neighbouring PUs. The intra prediction unit 322 may also determine an intra prediction mode for the PU according to one or more syntax elements parsed from the bitstream.

The inter prediction unit 321 can construct a first reference picture list (list 0) and a second reference picture list (list 1) according to the syntax elements parsed from the bitstream. In addition, the entropy decoding unit 310 may parse motion information of the PU if the PU is encoded using inter prediction. The inter prediction unit 321 may determine one or more reference blocks of the PU according to the motion information of the PU. The inter prediction unit 321 may generate a prediction block of the PU based on one or more reference blocks of the PU.

The inverse quantization/transform unit 330 may perform inverse quantization on (i.e., dequantize) a transform coefficient associated with a TU. The inverse quantization/transform unit 330 may use a QP value associated with a CU of the TU to determine the degree of quantization. After inverse quantization of the transform coefficient, the inverse quantization/transform unit 330 may perform one or more inverse transformations on the inverse-quantized transform coefficients in order to generate a residual block associated with the TU.

The reconstruction unit 340 uses the residual block associated with the TU of the CU and the prediction block of the PU of the CU to reconstruct a sample block of the CU. For example, the reconstruction unit 340 may add samples in the residual block to corresponding samples in the prediction block to reconstruct the sample block of the CU to obtain the reconstructed picture block.

The in-loop filtering unit 350 may perform deblocking filtering to reduce blocking artifacts of the sample block associated with the CU.

The video decoder 300 may store the reconstructed picture of the CU in the decoded picture buffer 360. The video decoder 300 may use the reconstructed picture in the decoded picture buffer 360 as a reference picture for subsequent prediction, or transmit the reconstructed picture to a display apparatus for display.

With reference to FIG. 2 and FIG. 4, a basic process of video coding is as follows.

At the encoding end, a picture is partitioned into blocks, and for a current block, the prediction unit 210 performs intra prediction or inter prediction to generate a prediction block of the current block (i.e., a block to-be-encoded). Based on the prediction block and an original block of the current block (i.e., the block to-be-encoded), the residual unit 220 may calculate a residual block, i.e., a difference between the prediction block and the original block. The residual block may also be referred to as residual information. The residual block can be transformed and quantized by the transform/quantization unit 230 to remove information that is not sensitive to human eyes, so as to eliminate visual redundancy. Optionally, the residual block before being transformed and quantized by the transform/quantization unit 230 may be called a time-domain residual block, and the time-domain residual block after being transformed and quantized by the transform/quantization unit 230 may be called a frequency residual block or a frequency-domain residual block. The entropy coding unit 280 receives a quantized transform coefficient output by the transform/quantization unit 230, and may perform entropy coding on the quantized transform coefficient to output a bitstream. For example, the entropy coding unit 280 can eliminate character redundancy according to a target context model and probability information of a binary bitstream.

At the decoding end, the entropy decoding unit 310 may parse the bitstream to obtain prediction information, a quantization coefficient matrix, etc. of a current block (i.e., a block to-be-decoded), and the prediction unit 320 performs intra prediction or inter prediction based on the prediction information to generate a prediction block of the current block (i.e., the block to-be-decoded). The inverse quantization/transform unit 330 uses the quantization coefficient matrix obtained from the bitstream to perform inverse quantization and inverse transform on the quantization coefficient matrix to obtain a residual block. The reconstruction unit 340 adds the prediction block and the residual block to obtain a reconstructed block. The reconstructed blocks form a reconstructed picture. The in-loop filtering unit 350 performs in-loop filtering on the reconstructed picture on a picture basis or on a block basis to obtain a decoded picture. It may be noted that, the encoding end also requires similar operations as the decoder to obtain the decoded picture. The decoded picture may also be referred to as a reconstructed picture, and the reconstructed picture may be a reference picture of a subsequent picture for inter prediction.

In addition, block partition information determined by the encoder, as well as mode information or parameter information for prediction, transformation, quantization, entropy coding, in-loop filtering, etc., are carried in the bitstream when necessary. The decoding end parses the bitstream and analyzes existing information to determine the block partition information, as well as the mode information or the parameter information for prediction, transformation, quantization, entropy coding, in-loop filtering, etc. the same as such information at the encoding end, so as to ensure the decoded picture obtained by the encoder is the same as the decoded picture obtained by the decoder.

It may be noted that, due to requirements of parallel processing, a picture may be partitioned into slices, etc. Slices in the same picture may be processed in parallel, that is, there is no data dependency between the slices. The term “frame” can be understood as a picture or a slice. In addition, the above is the basic process of the video codec under the block-based coding framework. With the development of technology, some modules or operations of the framework or process may be optimized. That is, this disclosure is not limited to the framework and process.

Joint video expert team (JVET), an international video coding standard development organization, has set up a group for research on a coding model beyond H.266/VVC, and the model, i.e., platform test software, is named as enhanced compression model (ECM). ECM has started to adopt newer and more efficient compression algorithms based on VTM10.0, and now has a higher coding performance than VVC by about 13%. ECM not only expands the size of a CU with a specific resolution, but also integrates many intra prediction and inter prediction technologies.

The related art involved in the disclosure will be described below.

### (1) Illuminance Compensation Technology

There are often changes in illuminance intensity of video contents in real natural video, such as decrease of illuminance intensity over time, obstruction of dark clouds, or change of flash intensity of a camera. The difference between previous and subsequent pictures in these video contents mainly lies in the intensity of the DC component of the picture, but there is substantially no change in texture information of the contents. However, due to influence of large DC component value, these contents cannot be predicted effectively by means of motion search and motion compensation in inter prediction technology, and more residual information are likely to be encoded. With local illuminance compensation (LIC) technology, it is possible to remove these DC redundant information, and predict luma changes accurately and implement corresponding compensation, which makes residual information smaller and improves coding efficiency. In the following, the LIC technology is referred to as illuminance compensation for the sake of brevity.

The latest video coding standard H.266/VVC has been finalized. JVET, an international video coding joint standard expert team, proposes to explore a video coding standard which is beyond VVC in coding performance on the basis of VVC, and conducts an exploratory experiment (EE2) for the purpose of beyond VVC. The platform reference software used in the exploratory experiment is based on VTM11.0. A new algorithm will be applied thereto and the branch will be changed to the ECM. In addition, multiple expert discussion groups are established for the ECM. The latest version 8.0 of the ECM reference software already has a higher coding performance than VVC by about 19%, while VVC, which is currently the latest standard, is higher by only about 27% than the previous-generation video coding standard H.265/HEVC in coding performance. It is likely to open a window for exploration and research on the next-generation video coding standard based on the ECM in the near future.

In the early stage of proposal of the ECM, coding tools which VVC does not support is already applied to the reference software, and these coding tools have high coding performance and processing capability for different coding scenarios in the ECM, including LIC. The following will give a brief introduction to the LIC in the ECM.

An illuminance compensation technology is an inter encoding technology. In an encoding process, for a current CU, a corresponding reference block is obtained according to an MV (MV information), where the reference block is usually from a different coding picture, in other words, a reference CU does not belong to a current picture. Different pictures have significant or slight change in some specific scenarios, and the illuminance compensation technology is effective for processing some of the changes.

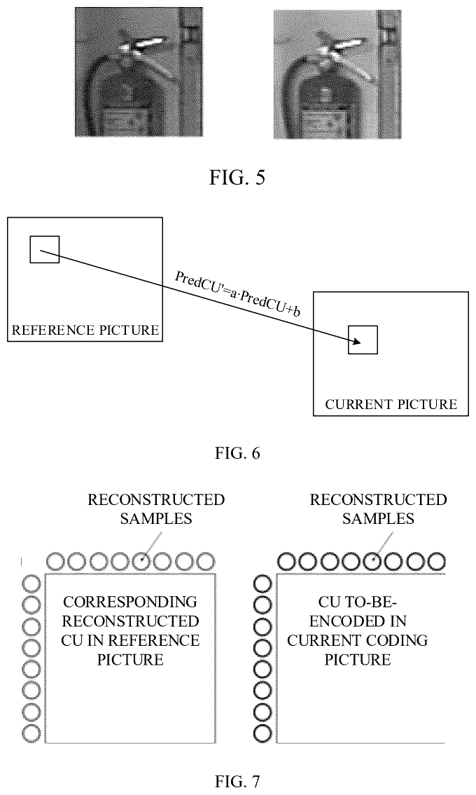

FIG. 5 is an example of pictures with different luma and substantially the same texture provided in the disclosure.

As illustrated in FIG. 5, texture information of left and right parts is substantially the same, and the difference lies in luma change between the two. Since a right picture appears very bright due to illuminance by a camera flash while a left picture is illuminated by normal natural light, there is difference between the two, and such difference results in heavy burden in video encoding. Supposing that a left block is used as a reference CU for a right block, the texture information of the two is the same, and therefore the difference in texture between the two is very slight, but an overall residual is very large. The reason is that samples in the right picture as a whole has an offset due to illuminance on the samples by the flash, and the residual between the two includes such offset. If the residual is directly transformed and quantized and then signalled into a bitstream, it will lead to high overhead.

In the illuminance compensation technology in the ECM reference software, these influences, such as influence caused by the flash or illuminance change, is eliminated by means of linear fitting, so as to achieve better overall prediction effect.

The illuminance compensation technology is mainly as follows.

A correlation of change between prediction samples in a CU and reference samples is fitted with aid of a correlation between neighbouring reconstructed samples of a reference CU and neighbouring reconstructed samples of the current CU. The reason is that top reconstructed samples and left reconstructed samples neighbouring the current CU can be obtained if they exist, and top reconstructed samples and left reconstructed samples neighbouring a reference CU in a reference picture can also be obtained. A corresponding fitting model can be obtained by modeling reconstructed samples of the current picture and reconstructed samples of the reference picture.

In the modeling process, illuminance compensation in the ECM is implemented through linear fitting, and the model is simplified as fitting illuminance change between the current picture and the reference picture with a scaling parameter a and an offset parameter b. The relationship of change is expressed by model parameters as follows.

$${Pred}^{′} ( x , y ) = a \cdot Pred ( x , y ) + b$$

Pred(x,y) is a prediction block before illuminance compensation, Pred′(x,y) is a prediction block after illuminance compensation, a is a scaling parameter of an illuminance compensation model, and b is an offset parameter of the illuminance compensation model. Both a and b in the formula are obtained by calculating picture information of the current picture (also referred to as a current frame) and picture information of the reference picture (also referred to as a reference frame), and are obtained by modeling reconstructed samples that are spatially neighbouring the current block and neighbouring samples of a reconstructed block in a corresponding reference picture. The derivation formula is as follows.

$${Curr\_Rec}_{neigh} = a \cdot {Ref\_Rec}_{neigh} + b$$

Curr_Rec_{neigh} is a reconstructed picture of the current picture, and Ref_Rec_{neigh} is a reconstructed picture of the reference picture. During coding of a digital video, a coding block in the current picture is refined with regard to illuminance difference by using the illuminance compensation model, to obtain a compensated prediction block, as illustrated in FIG. 6.

In addition, the scaling parameter a and the offset parameter b may be calculated according to neighbouring reconstructed samples of a reconstructed block corresponding to a current block in the reference picture and neighbouring reconstructed samples of the coding block in the current picture. The scaling parameter a and the offset parameter b are obtained by modeling according to the correlation between the neighbouring reconstructed samples of the CU in the current picture and reconstructed samples at corresponding positions in the reference picture.

FIG. 7 is an example of partitioning of a CTU and a CU provided in the disclosure.

As illustrated in FIG. 7, a linear relationship is obtained by modeling nearest neighbouring reconstructed samples (also referred to as reconstructed pixels) of corresponding CUs in a current picture and a reference picture, so as to obtain a scaling parameter a and an offset parameter b, and then the linear relationship is applied to a corresponding reconstructed CU in the reference picture (reference picture CU) to obtain a prediction block of a CU to-be-encoded in the current picture (current picture CU).

The specific modeling process is as follows.

The illuminance compensation model is a linear model in the ECM, and a model parameter includes the scaling factor a and the offset parameter b. The scaling factor a and the offset parameter b are obtained by means of least square error. The quantity of reconstructed samples to-be-selected is set according to the width and the height of the current CU. If at least one of the width or the height of the current CU is equal to 4, 4 reconstructed samples are selected from top neighbouring reconstructed samples of the CU and 4 reconstructed samples are selected from left neighbouring reconstructed samples of the CU. For example, if the current CU has a width of 16 and a height of 4, all the 4 left neighbouring reconstructed samples are selected, and 4 top neighbouring reconstructed samples are selected at a step of 3. If neither the width nor the height of the current CU is equal to 4, samples whose quantity is the logarithm of the minimum between the width and the height to 2 (log 2 (minimum between width and height)) are obtained from the top neighbouring reconstructed samples, and samples whose quantity is the logarithm of the minimum between the width and the height to 2 are obtained from the left neighbouring reconstructed samples.

The model parameters are calculated after obtaining the top reconstructed samples and the left reconstructed samples. Assuming that the obtained reconstructed sample of the reference picture is denoted by x and the reconstructed sample of the current picture is denoted by y, then the sum of the reconstructed samples of the reference picture is denoted by sumX, the sum of the reconstructed samples of the current picture is denoted by sumY, the sum of squares of the reconstructed samples of the reference picture is denoted by sumXX, and the sum of products of the reconstructed samples of the reference picture and the reconstructed samples of the current picture is denoted by sumXY. In this case, the parameters are calculated as follows.

$$a = ( sumXY - sumXsumY ) / ( sumXX - sumXsumX )$$

$$b = sumY - a * sumX$$

sumXsumY equals to sumX*sumY, and some shift operations involved in the calculation process in the ECM reference software are all simplified processes, which are not described in detail herein. After the linear model parameters are obtained, linear transformation is performed on a prediction block obtained after motion compensation, to obtain a final prediction block.

If the reconstructed sample for calculating the linear model parameters belongs to an inter prediction block, an interpolation operation is required.

The illuminance compensation technology in the ECM can be applied to common inter prediction, a merge prediction mode, and a sub-block mode. The common inter prediction is an inter mode. The merge prediction mode is a merge mode. The sub-block mode is an affine mode. In addition, the illuminance compensation technology is applicable only in a single-frame prediction mode, but is not applicable to a multi-frame bi-directional reference mode.

In addition, there is a relationship between the illuminance compensation technology in the ECM and another technology adopted. In the current CU, the illuminance compensation technology is not applied together with a bi-directional optical flow (BDOF) technology or a symmetric motion vector difference (symmetric MVD, SMVD) technology.

### (2) Application of Illuminance Compensation Technology in Intra Block Copy (IBC) Technology

Generally, the illuminance compensation technology is applied to inter prediction. However, in intra prediction, there is a technology similar to the inter prediction, i.e., the IBC technology. As indicated by the name, the IBC technology refers to searching in a current picture for a block that matches or is similar to a current block, copying the block, and then using the block as a prediction block of the current block. This is a prediction technology dedicated for screen content coding.

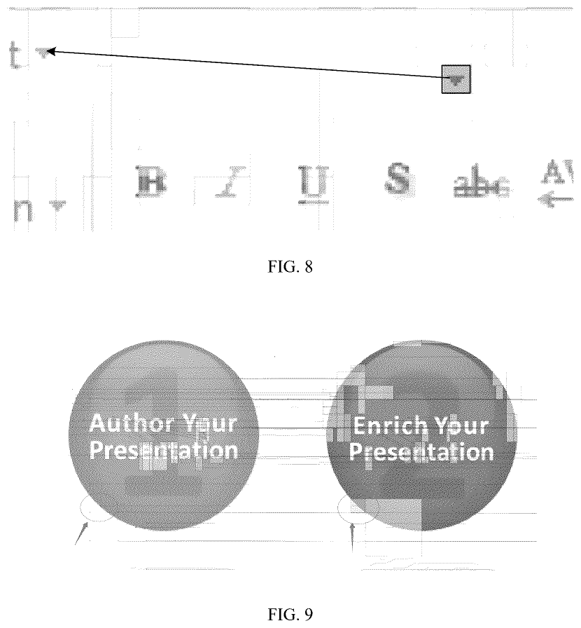

FIG. 8 is an example of IBC provided in the disclosure.

As illustrated in FIG. 8, there is an inverted-triangular graphic texture in a coding block. If traditional intra prediction technology is used for encoding a current block, a large amount of bit consumption is required for encoding residual information. In contrast, when IBC technology is used, a similar or identical block is found in the top-left corner through search within a specified range of a current picture. Through distortion cost calculation or hash value matching, a reconstructed block found is determined and copied to serve as a prediction block of the current block. As can be seen, this prediction technology is much more efficient than traditional intra coding technology. In some cases, even an identical prediction block can be found without encoding the residual information, thereby greatly saving bit overhead. In addition, a solid line with an arrow represents block vector (BV) information of the current block, and at the decoding end, a matched reconstructed block is found as the prediction block of the current block based on the BV.

Similar to inter prediction, there are two modes for IBC. One is an advanced motion vector prediction (AMVP) mode, and the other one is a skip/merge mode, i.e., a merge mode.

In the AMVP mode, for IBC, an index needs to be transmitted to indicate which block vector prediction (BVP) to use, and a block vector difference (BVD) needs to be encoded.

In the skip/merge mode, for IBC, an index needs to be transmitted to indicate which BV information to use.

Similar to inter prediction, in some application scenarios, even if texture information in a coding block is the same, there may be a difference in colour. In a natural sequence, the most common scenario is illuminance change. For example, when a camera fixedly focuses on a building, video content of the building taken in the morning may be the same as video content of the building taken in the afternoon, but the illuminance intensity changes. Therefore, even if a decoded reconstructed picture is used as reference content for inter prediction, the video content is unable to be completely represented. Due to different illuminance, the overall mean of the video content is different, which results in large consumption for encoding a required residual bitstream. With the illuminance compensation technology, such a problem can be solved. In particular, by establishing a linear model, transform is performed on the reference content and current content, thereby adapting to change between different illuminance intensities without changing texture content.

In short, a similar problem also exists in screen content coding. Even if the coding block has the same content, colour deviations or other problems may result in low coding efficiency of the IBC technology, or even a similar coding block may be unable to be found. For example, for four sub-pictures with picture contents of the same texture but different colours, large differences in colour may reduce the efficiency of block copy technology or even result in failure to match these reconstructed picture contents.

Similar to LIC technology, for intra block copy local illuminance compensation (IBC-LIC) technology, by establishing a linear relationship between a reference block and a coding block, a reference block is transformed and then used as a prediction block of a current CU, with the same process as that in the above LIC. In the AMVP mode, a flag is needed for IBC to indicate whether to use the LIC technology, while in the merge mode, the LIC technology is enabled or disabled through inheritance. For example, for four sub-pictures with picture contents of the same texture but different colours, after the IBC-LIC technology is enabled, starting from the second sub-picture, the IBC-LIC technology is used for more and more coding blocks to copy previously reconstructed sub-picture contents.

As can be seen from the above analysis, the IBC-LIC technology can provide very considerable performance in an application scenario of screen content coding, with the same calculation process as that in the LIC technology, and from both software and hardware levels, the complexity is acceptable and the cost performance is high.

However, for IBC-LIC, a method in LIC for modeling using a reference sample and a reconstructed sample in both a top template region and a left template region as inputs may not be well suited to the scenario of screen content coding. Generally, in a natural sequence, there may be the same illuminance change for content in a current picture, while in a screen content scenario, the content change occurs at a pixel level and is relatively sharp. The top template region may be able to reflect a linear relationship between a current block and a reference block, but the left template region may greatly differ from the current block, which may have a negative influence on establishing a linear model. For example, in some presentation application scenarios, colour change is very rapid and drastic, where some shapes are red, but a next shape to be switched to may be green. If the current CU has two colours, and reconstructed blocks for reference have the same texture but different colour changes, then the relationship of change between different colours may not be well reflected by parameters calculated using a template(s). The model parameters in this case are more like a trade-off fit.

FIG. 9 is an example of pictures with similar texture provided in the disclosure.

As illustrated in FIG. 9, it is assumed that a left sub-picture is an orange-background sub-picture and a right sub-picture is a blue-background sub-picture. The two sub-pictures share significant similarities in shapes and some colour gradients, and thus it is a very effective method for saving bitrates to copy edge shapes and then perform colour compensation. However, for a coding block at an edge of the right sub-picture, since a region covered by a template of the coding block usually has multiple colours, and a prediction block also has different colours, model fitting is not accurate enough, which in turn reduces the encoding performance of an encoder and the decoding performance of a decoder.

For example, for a prediction block at the bottom-left corner of the right sub-picture, when reference is made to the same part of the left sub-picture, curve contours and colour changes are almost identical, which can save a lot of bits for the coding block. However, since a linear relationship between white and white and a linear relationship between orange and blue are mixed during calculation in the template region, calculated linear model parameters are inaccurate, which reduces the effect of linear transformation on the prediction block. Specifically, a blue region in the prediction block is obtained through linear transformation on an orange region in a reference block, but since a large proportion of white-to-white linear fitting participates in the calculation of parameters, a change in colour difference from orange to blue is insufficient. Similarly, the white part should have remained unchanged, but since orange-to-blue linear fitting leads to a change in the parameters, the resulting white colour has a colour difference. Ultimately, residuals of the prediction block are more than expected, and the encoding efficiency is greatly reduced, and accordingly, the decoding efficiency of the decoder is also reduced. In view of this, a decoding method, an encoding method, a decoder, and an encoder are provided in the disclosure, which can improve the decoding performance.

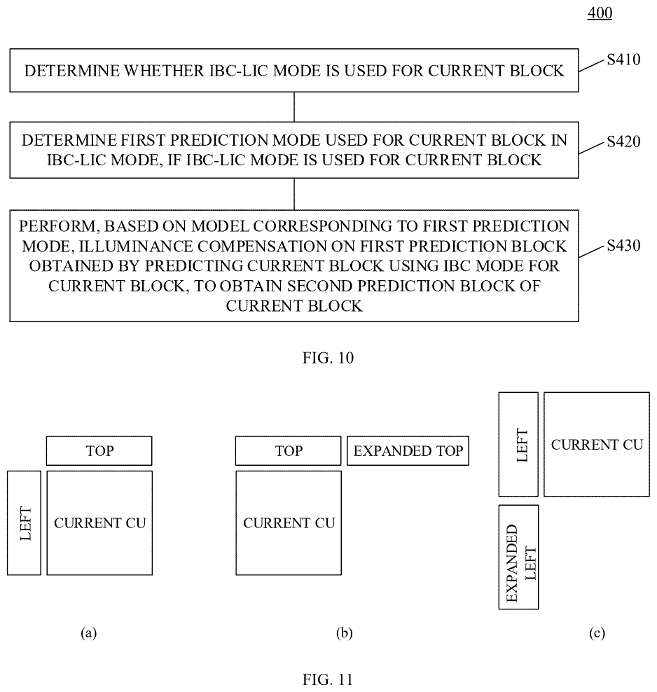

FIG. 10 is a schematic flowchart of a decoding method 400 provided in the disclosure. It may be understood that, the decoding method 400 may be performed by a decoder. For example, the decoding method 400 may be performed by the video decoder 122 illustrated in FIG. 1 or the video decoder 300 illustrated in FIG. 4. For ease of description, the decoder will be taken as an example for illustration.

As illustrated in FIG. 10, the decoding method 400 may include part or all of the following.

At S410, a decoder determines whether an IBC-LIC mode is used for a current block.

Exemplarily, the IBC-LIC mode may be an IBC-LIC mode in an IBC AMVP mode or an IBC-LIC mode in an IBC merge mode.

In other words, the decoder determines whether the IBC-LIC mode in the IBC AMVP mode or the IBC-LIC mode in the IBC merge mode is used for the current block.

It may be noted that, the IBC-LIC mode means that LIC technology is used for illuminance compensation on a prediction block obtained by predicting the current block using IBC. In other alternative embodiments, the IBC-LIC mode may be referred to as a prediction mode corresponding to IBC and LIC, a compensation mode corresponding to IBC and LIC, or other terms with similar meaning, which is not limited in the disclosure.

At S420, if the IBC-LIC mode is used for the current block, the decoder determines a first prediction mode used for the current block in the IBC-LIC mode.

Exemplarily, the first prediction mode is a sub-mode of the IBC-LIC mode.

Exemplarily, the first prediction mode is a certain type of IBC-LIC mode.

Exemplarily, the first prediction mode is an IBC-LIC mode corresponding to a specific model.

For example, the first prediction mode may be a sub-mode of the IBC-LIC mode in the IBC AMVP mode.

For another example, the first prediction mode may be a sub-mode of the IBC-LIC mode in the IBC merge mode.

At S430, the decoder performs, based on a model corresponding to the first prediction mode, illuminance compensation on a first prediction block obtained by predicting the current block using an IBC mode for the current block, to obtain a second prediction block of the current block.

Exemplarily, the IBC mode for the current block may be the IBC AMVP mode or the IBC merge mode.

Exemplarily, when the IBC mode for the current block is the IBC AMVP mode, the first prediction mode is the sub-mode of the IBC-LIC mode in the IBC AMVP mode. In this case, the decoder may perform, based on the model corresponding to the first prediction mode, illuminance compensation on the first prediction block obtained by predicting the current block using the IBC AMVP mode, to obtain the second prediction block of the current block.

Exemplarily, when the IBC mode for the current block is the IBC merge mode, the first prediction mode is the sub-mode of the IBC-LIC mode in the IBC merge mode. In this case, the decoder may perform, based on the model corresponding to the first prediction mode, illuminance compensation on the first prediction block obtained by predicting the current block using the IBC merge mode, to obtain the second prediction block of the current block.

Exemplarily, after the decoder obtains the first prediction block by predicting the current block based on the IBC mode for the current block, the decoder determines a model parameter of the model corresponding to the first prediction mode based on a format of the model corresponding to the first prediction mode. Then, the decoder may perform illuminance compensation on the first prediction block based on the model parameter of the first model, to obtain the second prediction block. Optionally, the format of the model corresponding to the first prediction mode includes, but is not limited to, information such as the number of models corresponding to the first prediction mode, a template region for the model corresponding to the first prediction mode, and an adjustment parameter corresponding to the first prediction mode. Certainly, the information included in the above format is merely taken as an example of the disclosure.

It may be noted that, the model parameter of the model corresponding to the first prediction mode includes the scaling parameter a and the offset parameter b described above, and for a calculation manner of the model parameter, reference can be made to the calculation formulas of the scaling parameter a and the offset parameter b. Similarly, when the decoder performs illuminance compensation on the first prediction block based on the model corresponding to the first prediction mode, the decoder may apply this linear relationship to the first prediction block to obtain the second prediction block. For a specific compensation method, reference can be made to the contents related to FIG. 6, which will not be repeated herein.

In this embodiment, for the decoding method provided in the disclosure, if the IBC-LIC mode is used for the current block, the first prediction mode used for the current block in the IBC-LIC mode needs to be further determined, and then based on the model corresponding to the first prediction mode, illuminance compensation is performed on the first prediction block obtained by predicting the current block using the IBC mode for the current block, to obtain the second prediction block of the current block. In other words, the IPBC-LIC mode is subdivided into prediction modes, and models are associated with the prediction modes, thereby avoiding the use of a unified model for illuminance compensation and improving the decoding performance of the decoder.

Beneficial effects of the solutions provided in the disclosure will be described below based on test results.

Table 1 illustrates test results obtained after the decoding method provided in the disclosure is integrated into the latest ECM8.0.

TABLE 1

All intra Main10
Over ECM8.0

| | Y | U | V | EncT | DecT |
|---|---|---|---|---|---|
| Class F | −0.23% | −0.10% | −0.08% | 119% | 104% |
| Class TGM | −0.08% | −0.08% | −0.11% | 119% | 110% |

As illustrated in Table 1, class F and class TGM are sequence classes dedicated for screen content coding, where sequences SlideShow and SlideEditing in class F are the application scenarios described above. In the table, Y represents luminance (Luma), U represents blue chrominance, V represents red chrominance, and a corresponding value thereof being a negative number indicates performance gains. EncT represents the transform of encoding complexity, and DecT represents the transform of complexity. As can be seen from simulation results, according to the decoding method provided in the disclosure, the decoding performance can be improved, especially with the most significant gains in class F.

In some embodiments, operations at S420 may include the following. A bitstream is decoded to determine a first index. The first index indicates the first prediction mode in at least one mode.

Exemplarily, the at least one mode may be at least one IBC-LIC mode. For example, the at least one mode may be at least one IBC-LIC mode belonging to the IBC AMVP mode. In other words, the first index may indicate the first prediction mode in the at least one IBC-LIC mode belonging to the IBC AMVP mode. In this case, when the IBC mode for the current block is the IBC AMVP mode, the decoder decodes the bitstream to determine the first index, and performs, based on the model corresponding to the first prediction mode indicated by the first index, illuminance compensation on the first prediction block obtained by predicting the current block using the IBC AMVP mode, to obtain the second prediction block of the current block.

Certainly, in other alternative embodiments, when the IBC mode for the current block is the IBC merge mode, the decoder may decode the bitstream to determine the first index, and determine as the first prediction mode a prediction mode indicated by the first index. This disclosure is not limited in this regard. In addition, a manner of parsing the first index is not limited in the disclosure. For example, the first index may be parsed in a context-based manner or in an equiprobable manner.

In some embodiments, the first index indicates the first prediction mode in the ordered at least one mode. The method 400 may further include the following. A distortion cost of the at least one mode is determined, where a distortion cost of any mode in the at least one mode is determined based on a reconstructed sample in a template region of the current block and a sample obtained by performing illuminance compensation on at least one prediction sample using a model corresponding to the any mode, and the at least one prediction sample includes a prediction sample obtained by predicting a sample in the template region of the current block using the IBC-LIC mode. The ordered at least one mode is obtained by ordering the at least one mode based on the distortion cost of the at least one mode.

Exemplarily, the distortion cost may be any cost capable of characterizing a difference, such as sum of absolute differences (SAD) and transform-based sum of absolute transformed differences (SATD).

Exemplarily, a codeword of the first index is correlated with a position of the first prediction mode in the ordered at least one mode. For example, the codeword of the first index is negatively correlated with the position of the first prediction mode in the ordered at least one mode. That is, when the position of the first prediction mode in the ordered at least one mode is more in the front, the codeword of the first index is smaller, thereby reducing the codeword of the first index. For an encoder, the encoder may order modes according to distortion costs. A mode with a low cost is encoded and transmitted with a shorter codeword, and a mode with a high cost is transmitted with a longer codeword. As such, the encoding efficiency of the encoder and the decoding efficiency of the decoder can be improved.

In some embodiments, the method 400 may further include the following. A first model is determined based on a reconstructed sample in a template region of the current block and a reconstructed sample in a template region of the first prediction block. The at least one mode includes a first mode corresponding to the first model.

Exemplarily, the decoder may determine a model parameter of the first model based on the reconstructed sample in the template region of the current block and the reconstructed sample in the template region of the first prediction block. Optionally, the model parameter of the first model may include the scaling parameter a and the offset parameter b described above. For a calculation manner of the model parameter, reference can be made to the calculation formulas of the scaling parameter a and the offset parameter b, which will not be repeated herein.

It may be noted that, a position of the template region of the current block relative to the current block may be the same as or different from a position of the template region of the first prediction block relative to the first prediction block, which is not limited in the disclosure.

In some embodiments, the method 400 may further include the following. A second model is obtained by adjusting a parameter of the first model based on an adjustment value corresponding to the first mode. The at least one mode includes a second mode corresponding to the second model.

Exemplarily, the decoder may obtain a model parameter of the second model by adjusting the parameter of the first model based on the adjustment value corresponding to the first model. Optionally, the model parameter of the first model may include the scaling parameter a and the offset parameter b described above, and an adjustment parameter includes an adjustment amount of the scaling parameter a and/or an adjustment amount of the offset parameter b.

For example, when the decoder adjusts the scaling parameter a of the first model, the decoder may obtain the scaling parameter a of the second model in any one of the following manners: multiplying the scaling parameter a of the first model by the adjustment amount of the scaling parameter a, subtracting the adjustment amount of the scaling parameter a from the scaling parameter a of the first model, or adding the scaling parameter a of the first model and the adjustment amount of the scaling parameter a. Similarly, when the decoder adjusts the offset parameter b of the first model, the decoder may obtain the offset parameter b of the second model in any one of the following manners: multiplying the offset parameter b of the first model by the adjustment amount of the offset parameter b, subtracting the adjustment amount of the offset parameter b from the offset parameter b of the first model, or adding the offset parameter b of the first model and the adjustment amount of the offset parameter b.

In some embodiments, the method 400 may further include the following. Multiple third models are determined. Any one of the multiple third models is determined based on a first sample group obtained by partitioning reconstructed samples in a template region of the current block and a second sample group obtained by partitioning prediction samples in a template region of the first prediction block, and the at least one mode includes a third mode corresponding to the multiple third models.

Exemplarily, a model parameter of the any third model may be determined based on reconstructed samples in the first sample group and reconstructed samples in the second sample group. Optionally, the model parameter of the any third model may include the scaling parameter a and the offset parameter b described above. For a calculation manner of the model parameter, reference can be made to the calculation formulas of the scaling parameter a and the offset parameter b, which will not be repeated herein.

In some embodiments, the method 400 may further include the following. Multiple fourth models are obtained by adjusting parameters of the multiple third models based on an adjustment value corresponding to the third mode. The at least one mode includes a fourth mode corresponding to the multiple fourth models.

Exemplarily, the decoder may obtain model parameters of the multiple fourth models by adjusting the parameters of the multiple third models based on the adjustment value corresponding to the third mode. Optionally, a model parameter of any one of the multiple third models may include the scaling parameter a and the offset parameter b described above. Optionally, an adjustment parameter includes an adjustment amount of the scaling parameter a and/or an adjustment amount of the offset parameter b. Optionally, the adjustment value corresponding to the third mode may include an adjustment value corresponding to each of the multiple third models, or the adjustment value corresponding to the third mode may include an adjustment value shared by the multiple third models.

An example that the adjustment value shared by the multiple third models includes the adjustment amount of the scaling parameter a and/or the adjustment amount of the offset parameter b will be taken below for illustration.

For example, when the decoder adjusts the scaling parameter a of each third model, the decoder may obtain the scaling parameters a of the multiple fourth models in any one of the following manners: multiplying the scaling parameter a of each third model by the adjustment amount of the scaling parameter a, subtracting the adjustment amount of the scaling parameter a from the scaling parameter a of each third model, or adding the scaling parameter a of each third model and the adjustment amount of the scaling parameter a. Similarly, when the decoder adjusts the offset parameter b of each third model, the decoder may obtain the offset parameters b of the multiple fourth models in any one of the following manners: multiplying the offset parameter b of each third model by the adjustment amount of the offset parameter b, subtracting the adjustment amount of the offset parameter b from the offset parameter b of each third model, or adding the offset parameter b of each third model and the adjustment amount of the offset parameter b.

In some embodiments, the method 400 may further include the following. Reconstructed samples in the template region of the first prediction block are partitioned into multiple sample groups based on values of the reconstructed samples in the template region of the first prediction block, where the second sample group is any one of the multiple sample groups. Reconstructed samples with positions corresponding to the second sample group in the template region of the current block are partitioned into the first sample group.

Exemplarily, the decoder partitions the reconstructed samples in the template region of the first prediction block into the multiple sample groups based on the values of the reconstructed samples in the template region of the first prediction block, where the second sample group is any one of the multiple sample groups. Further, the decoder partitions the reconstructed samples with the positions corresponding to the second sample group in the template region of the current block into the first sample group. Based on this, the decoder may determine the multiple third models based on each second sample group obtained by partitioning the reconstructed samples in the template region of the first prediction block and a first sample group corresponding to the second sample group.

Exemplarily, the decoder may partition the reconstructed samples in the template region of the first prediction block into one or more second sample groups based on at least one value range pre-defined. Alternatively, the decoder may determine at least one value range based on the reconstructed samples in the template region of the first prediction block, and then partition the reconstructed samples in the template region of the first prediction block into one or more second sample groups based on the at least one value range.

Exemplarily, the at least one value range pre-defined may be implemented by pre-storing a corresponding code(s) or a corresponding table(s) in the decoder or in other manners that can be used for indicating related information, or the at least one value range pre-defined may be specified or defined in a standard protocol.

Exemplarily, the at least one value range may be at least one absolute-value range. Accordingly, the decoder may partition, based on a value of any reconstructed sample in the template region of the first prediction block, the any reconstructed sample into a value range to which the value of the any reconstructed sample belongs.

Exemplarily, the decoder may use multiple values to characterize or determine the at least one value range.

Exemplarily, the at least one value range may be in one-to-one correspondence with at least one group, or the at least one value range may be in many-to-one correspondence with the at least one group.

In this embodiment, the decoder partitions the reconstructed samples in the template region of the first prediction block into the multiple sample groups based on the values of the reconstructed samples in the template region of the first prediction block, and partitions the reconstructed samples in the template region of the current block based on a partition result for the reconstructed samples in the template region of the first prediction block. As such, the multiple third models can match the distribution of the reconstructed samples in the template region of the first prediction block as much as possible, thereby improving the illuminance compensation effect of the multiple third models and improving the decoding performance of the decoder.

Certainly, the “sample group” involved in the disclosure can also be understood as or equivalently replaced with a “set”, a “group”, or other terms with similar meaning.

In some embodiments, an average of the reconstructed samples in the template region of the first prediction block is determined. The reconstructed samples in the template region of the first prediction block are partitioned into the multiple sample groups based on the average. The multiple sample groups include a sample group in which values of reconstructed samples are greater than or equal to the average and a sample group in which values of reconstructed samples are less than the average.

Exemplarily, when the multiple third models are two third models, the decoder may partition, based on the average, the reconstructed samples in the template region of the first prediction block into a sample group in which values of reconstructed samples are greater than or equal to the average and a sample group in which values of reconstructed samples are less than the average.

Certainly, in other alternative embodiments, the decoder may partition reconstructed samples each with an offset less than or equal to a preset threshold in the template region of the first prediction block into reconstructed samples in one sample group, or may partition the reconstructed samples in the template region of the first prediction block in another manner. Alternatively, the decoder first partitions the reconstructed samples in the template region of the current block, and then partitions the reconstructed samples in the template region of the first prediction block based on a partition result for the reconstructed samples in the template region of the current block, which is not limited in the disclosure.

In some embodiments, the template region of the current block includes a top template region and/or a left template region.

Exemplarily, the template region of the current block may be only the top template region, or the template region of the current block may be only the left template region, or the template region of the current block may include both the top template region and the left template region. For example, in the case where the decoder determines the first model based on the reconstructed sample in the template region of the current block and the reconstructed sample in the template region of the first prediction block, the decoder obtains a top template region of the first prediction block and a top template region of the current block after obtaining the first prediction block by predicting the current block based on the IBC mode for the current block, and calculates the model parameter of the first model based on the top template region of the first prediction block and the top template region of the current block.

In this embodiment, it is proposed to introduce illuminance compensation based on only the top template region or only the left template region. In other words, a scheme where samples in only a single-side template region are used for calculating linear model parameters and then illuminance compensation is performed is proposed, which can improve the flexibility and compensation effect of illuminance compensation.

Exemplarily, the top template region includes, but is not limited to, at least one of a template region directly above, a template region on the top left, or a template region on the top right.

For example, taking the top template region of the current block as an example, the top template region of the current block may be a template region directly above the current block, or may include the template region directly above the current block and a template region on the top left of the current block, or may include the template region directly above the current block and a template region on the top right of the current block, or may even include the template region on the top left of the current block, the template region directly above the current block, and the template region on the top right of the current block. The template region directly above the current block may refer to a template region above the current block with the left boundary aligned with the left boundary of the current block and the right boundary aligned with the right boundary of the current block. The template region on the top right of the current block may refer to a template region above the current block with the left boundary corresponding to the right boundary of the current block. The template region on the top left of the current block may refer to a template region above the current block with the right boundary corresponding to the left boundary of the current block.

Exemplarily, the left template region includes, but is not limited to, at least one of a template region directly on the left, a template region on the top left, or a template region on the bottom left.

For example, taking the left template region of the current block as an example, the left template region of the current block may be a template region directly on the left of the current block, or may include the template region directly on the left of the current block and a template region on the top left of the current block, or may include the template region directly on the left of the current block and a template region on the bottom left of the current block, or may even include the template region directly on the left of the current block, the template region on the top left of the current block, and the template region on the bottom left of the current block. The template region directly on the left of the current block may refer to a template region on the left of the current block with the top boundary aligned with the top boundary of the current block and the bottom boundary aligned with the bottom boundary of the current block. The template region on the top left of the current block may refer to a template region on the left of the current block with the bottom boundary corresponding to the top boundary of the current block. The template region on the bottom left of the current block may refer to a template region on the left of the current block with the top boundary corresponding to the bottom boundary of the current block.

In some embodiments, a sampling step used when the template region of the current block is the top template region or the left template region is less than a sampling step used when the template region of the current block includes the top template region and the left template region. A sample obtained in the template region of the current block according to the sampling step is used for determining a model corresponding to a mode in the at least one mode.

Exemplarily, a difference between the sampling step used when the template region of the current block includes the top template region and the left template region and the sampling step used when the template region of the current block is the top template region or the left template region is a preset value, and the preset value is any value greater than 0. For example, the difference between the sampling step used when the template region of the current block includes the top template region and the left template region and the sampling step used when the template region of the current block is the top template region or the left template region is 2 or another value.

Exemplarily, the sampling step used when the template region of the current block includes the top template region and the left template region is a multiple of the sampling step used when the template region of the current block is the top template region or the left template region. For example, the sampling step used when the template region of the current block includes the top template region and the left template region is twice or another multiple of the sampling step used when the template region of the current block is the top template region or the left template region.

Compared with calculating model parameters using the top template region separately, more samples are generally used for calculating the model parameters using samples in both the top template region and the left template region, and accordingly, the model accuracy for calculating the model parameters using the samples in both the top template region and the left template region is higher than the model accuracy for calculating the model parameters using the top template region separately. In this embodiment, a sampling step is reduced to increase the number of samples participating in model calculation, and even all available samples in a template region are selected for calculating linear model parameters, thereby improving the model accuracy for calculating the model parameters using the top template region or the left template region separately.

In some embodiments, the number of sample rows of the top template region when the template region of the current block is the top template region is greater than the number of sample rows of the top template region when the template region of the current block includes the top template region and the left template region, and/or the number of sample columns of the top template region when the template region of the current block is the top template region is greater than the number of sample columns of the top template region when the template region of the current block includes the top template region and the left template region.

Exemplarily, the number of sample rows of the top template region when the template region of the current block is the top template region is greater by N (a positive integer) than the number of sample rows of the top template region when the template region of the current block includes the top template region and the left template region. Alternatively, the number of sample rows of the top template region when the template region of the current block is the top template region is a multiple of the number of sample rows of the top template region when the template region of the current block includes the top template region and the left template region. For example, the number of sample rows of the top template region when the template region of the current block is the top template region is twice or another multiple of the number of sample rows of the top template region when the template region of the current block includes the top template region and the left template region.

Exemplarily, the number of sample columns of the top template region when the template region of the current block is the top template region is greater by M (a positive integer) than the number of sample columns of the top template region when the template region of the current block includes the top template region and the left template region. Alternatively, the number of sample columns of the top template region when the template region of the current block is the top template region is a multiple of the number of sample columns of the top template region when the template region of the current block includes the top template region and the left template region. For example, the number of sample columns of the top template region when the template region of the current block is the top template region is twice or another multiple of the number of sample columns of the top template region when the template region of the current block includes the top template region and the left template region.

Compared with calculating model parameters using the top template region separately, more samples are generally used for calculating the model parameters using samples in both the top template region and the left template region, and accordingly, the model accuracy for calculating the model parameters using the samples in both the top template region and the left template region is higher than the model accuracy for calculating the model parameters using the top template region separately. In this embodiment, an area of a template region is expanded to obtain broader and more spatial information, thereby improving the model accuracy for calculating the model parameters using the top template region separately.

In some embodiments, the number of sample rows of the left template region when the template region of the current block is the left template region is greater than the number of sample rows of the left template region when the template region of the current block includes the top template region and the left template region, and/or the number of sample columns of the left template region when the template region of the current block is the left template region is greater than the number of sample columns of the left template region when the template region of the current block includes the top template region and the left template region.

Exemplarily, the number of sample rows of the left template region when the template region of the current block is the left template region is greater by N (a positive integer) than the number of sample rows of the left template region when the template region of the current block includes the top template region and the left template region. Alternatively, the number of sample rows of the left template region when the template region of the current block is the left template region is a multiple of the number of sample rows of the left template region when the template region of the current block includes the top template region and the left template region. For example, the number of sample rows of the left template region when the template region of the current block is the left template region is twice or another multiple of the number of sample rows of the left template region when the template region of the current block includes the top template region and the left template region.

Exemplarily, the number of sample columns of the left template region when the template region of the current block is the left template region is greater by M (a positive integer) than the number of sample columns of the left template region when the template region of the current block includes the top template region and the left template region. Alternatively, the number of sample columns of the left template region when the template region of the current block is the left template region is a multiple of the number of sample columns of the left template region when the template region of the current block includes the top template region and the left template region. For example, the number of sample columns of the left template region when the template region of the current block is the left template region is twice or another multiple of the number of sample columns of the left template region when the template region of the current block includes the top template region and the left template region.

Compared with calculating model parameters using the left template region separately, more samples are generally used for calculating the model parameters using samples in both the top template region and the left template region, and accordingly, the model accuracy for calculating the model parameters using the samples in both the top template region and the left template region is higher than the model accuracy for calculating the model parameters using the left template region separately. In this embodiment, an area of a template region is expanded to obtain broader and more spatial information, thereby improving the model accuracy for calculating the model parameters using the left template region separately.

FIG. 11 is an example of template regions of a current block provided in the disclosure.

As illustrated in FIG. 11, (a) in FIG. 11 is an example in which the template region of the current block includes both a top template region and a left template region, (b) in FIG. 11 is an example in which the template region of the current block includes only the top template region, and (c) in FIG. 11 is an example in which the template region of the current block includes only the left template region. As illustrated in FIG. 11, in the case where the template region of the current block includes only the top template region or the left template region, the template region may be directly expanded. For example, as illustrated in (b) in FIG. 11, when the template region of the current block includes only the top template region, a template height may remain unchanged, and a width of the template region is increased (i.e., an expanded top template region is added). As illustrated in (c) in FIG. 11, when the template region of the current block includes only the left template region, a template width may remain unchanged, and a height of the template region is increased (i.e., an expanded left template region is added).

Certainly, the number of reference rows in the template region may also be increased to increase the number of samples and obtain more spatial information. For example, the top template region consists of two, three, or four rows of reconstructed samples, while the left template region consists of two, three, or four columns of reconstructed samples. In the disclosure, the template region is expanded, and in different expansion manners, more samples and more spatial information can participate in the calculation of model parameters. Even in some embodiments, for the selection of the template region of the current block, boundary check may also be introduced to the decoder. For example, for an unavailable sample(s), the decoder calculates the model parameters using part of available samples in the template region or not using the template region.

In some embodiments, the operations at S420 may include the following. A bitstream is decoded to determine at least one index, where the at least one index includes at least one of: an index indicating whether the model corresponding to the first prediction mode is a single model or a multi-model, an index indicating a template region for the model corresponding to the first prediction mode, an index indicating whether the model corresponding to the first prediction mode is a parameter-adjusted model, or an adjustment parameter corresponding to the first prediction mode. The first prediction mode is determined based on the at least one index.

Exemplarily, when the IBC mode for the current block is the IBC AMVP mode, the decoder decodes the bitstream to determine the at least one index, and determines the first prediction mode based on the at least one index. Then, based on the model corresponding to the first prediction mode, the decoder performs illuminance compensation on the first prediction block obtained by predicting the current block using the IBC AMVP mode, to obtain the second prediction block of the current block.

Certainly, in other alternative embodiments, when the IBC mode for the current block is the IBC merge mode, the decoder may decode the bitstream to determine the at least one index, and determine the first prediction mode based on the at least one index. This disclosure is not limited in this regard. In addition, a manner of parsing the at least one index is not limited in the disclosure. For example, the at least one index may be parsed in a context-based manner or in an equiprobable manner.

In some embodiments, operations at S410 may include the following. If the IBC mode for the current block is an IBC AMVP mode, a bitstream is decoded to determine a first flag. If the first flag indicates that the IBC-LIC mode is enabled for the current block, it is determined that the IBC-LIC mode is used for the current block.

Exemplarily, if the IBC mode for the current block is the IBC AMVP mode, the decoder obtains the first flag by parsing the bitstream. If the first flag indicates that the IBC-LIC mode is enabled for the current block, the decoder obtains a first index by decoding the bitstream, where the first index indicates the first prediction mode in at least one mode. Based on this, the decoder may perform, based on the model corresponding to the first prediction mode, illuminance compensation on the first prediction block obtained by predicting the current block using the IBC mode for the current block, to obtain the second prediction block of the current block.

In some embodiments, the operations at S410 may include the following. If the IBC mode for the current block is an IBC merge mode, a merge candidate list is constructed. A second index is determined, where the second index indicates a BV from the current block to a first reference block of the current block in the merge candidate list. If the IBC-LIC mode is used for the first reference block, it is determined that the IBC-LIC mode is used for the current block.

Exemplarily, if the IBC mode for the current block is the IBC merge mode, the decoder constructs the merge candidate list. Then, the decoder obtains the second index by parsing the bitstream, where the second index indicates the BV from the current block to the first reference block of the current block in the merge candidate list. If the IBC-LIC mode is used for the first reference block, the decoder determines that the IBC-LIC mode is used for the current block. If the IBC-LIC mode is not used for the first reference block, the decoder determines that the IBC-LIC mode is not used for the current block.

In addition, for the current block, different colour components are decoded independently from each other. For example, if a luma component has been decoded, a current colour component to-be-decoded is a chroma component, and MV information/BV information needs to be obtained from the luma component, then an IBC-LIC usage flag of the luma component may also be inherited.

In some embodiments, the operations at S420 may include the following. A prediction mode for the first reference block is determined as the first prediction mode.

Exemplarily, if the IBC mode for the current block is the IBC merge mode, the decoder constructs the merge candidate list. Then, the decoder obtains the second index by parsing the bitstream, where the second index indicates the BV from the current block to the first reference block of the current block in the merge candidate list. If the IBC-LIC mode is used for the first reference block, the decoder determines the prediction mode for the first reference block as the first prediction mode.

Certainly, in other alternative embodiments, if the IBC mode for the current block is the IBC merge mode, the decoder may determine in other manners whether the IBC-LIC mode is used or not used for the current block, and determine the first prediction mode in other manners when the IBC-LIC mode is used for the current block. This disclosure is not limited in this regard. For example, for IBC-LIC technology in a merge mode, the IBC-LIC mode for the current block may not be obtained through inheritance, that is, the first prediction mode is determined based on a scheme similar to AMVP IBC-LIC or a default prediction mode. For another example, for IBC-LIC technology in a merge mode, whether to use IBC-LIC may not be determined through inheritance of neighbouring information, and instead the encoder may perform distortion cost calculation and transmit whether to use IBC-LIC to the decoding end in the form of a flag and an index, and then the decoding end parses a usage flag of this technology in the merge mode to determine whether the IBC-LIC technology is used for a current CU.

In some embodiments, before the operations at S410, the method further includes the following. A second flag is obtained, where the second flag indicates whether the IBC mode for the current block is an IBC merge mode.

Exemplarily, if the second flag indicates that the IBC mode for the current block is the IBC merge mode, the decoder determines that the IBC mode for the current block is the IBC merge mode. Further, the decoder constructs the merge candidate list, and then obtains the second index by parsing the bitstream, where the second index indicates the BV from the current block to the first reference block of the current block in the merge candidate list. If the IBC-LIC mode is used for the first reference block, the decoder determines that the IBC-LIC mode is used for the current block. Further, the decoder may determine as the first prediction mode for the current block a prediction mode used for illuminance compensation on the first reference block.

Exemplarily, if the second flag indicates that the IBC mode for the current block is not the IBC merge mode, the decoder determines that the IBC mode for the current block is the IBC AMVP mode. Further, the decoder obtains the first flag by parsing the bitstream. If the first flag indicates that the IBC-LIC mode is enabled for the current block, the decoder obtains a first index by decoding the bitstream, and determines as a prediction mode for the current block a prediction mode indicated by the first index.

In some embodiments, operations at S430 may include the following. If the first prediction mode corresponds to a single model, illuminance compensation is performed on a prediction sample in the first prediction block based on the single model, to obtain the second prediction block.

Exemplarily, if the first prediction mode is the first mode or the second mode described above, that is, the model corresponding to the first prediction mode is the first model or the second model described above, then the decoder performs illuminance compensation on the predicted sample in the first prediction block based on the single model, to obtain the second prediction block.

In some embodiments, the operations at S430 may include the following. If the first prediction mode corresponds to multiple models, a model for any prediction sample in the first prediction block is determined from the multiple models. Illuminance compensation is performed on the any prediction sample based on the model for the any prediction sample, to obtain the second prediction block.

Exemplarily, if the first prediction mode is the third mode described above, that is, the model corresponding to the first prediction mode includes the multiple third models described above, then the decoder determines a third model for any prediction sample in the first prediction block from the multiple third models, and performs illuminance compensation on the any prediction sample based on the third model for the any prediction sample, to obtain the second prediction block.

Exemplarily, if the first prediction mode is the fourth mode described above, that is, the model corresponding to the first prediction mode includes the multiple fourth models described above, then the decoder determines a fourth model for any prediction sample in the first prediction block from the multiple fourth models, and performs illuminance compensation on the any prediction sample based on the fourth model for the any prediction sample, to obtain the second prediction block.

In some embodiments, the decoder determines a model corresponding to a range of a value of the any prediction sample among the multiple models as the model for the any prediction sample.

Exemplarily, the model corresponding to the range may refer to a model determined based on a range obtained by partitioning the reconstructed samples in the template region of the current block. In other words, the decoder may determine among the multiple models a model corresponding to a range for model determining in which the value of the any prediction sample is located as the model for the any prediction sample.

In some embodiments, the operations at S410 may include the following. If at least one of the following conditions is satisfied, it is determined whether the IBC-LIC mode is used for the current block. A prediction type for the current block is the IBC mode. The IBC-LIC mode is enabled for a current sequence to which the current block belongs. An area of the current block is greater than or equal to a preset first threshold. The area of the current block is less than or equal to a preset second threshold. A type of a current picture to which the current block belongs is a preset type. The IBC mode for the current block is not a mode of a type that is not used concurrently with the IBC-LIC mode.

Exemplarily, the preset type may be an I-picture type.

In other words, the use of the decoding method provided in the disclosure may be limited based on a type of a picture. For example, the decoding method provided in the disclosure is enabled only when the type of the current picture is an I picture, and the decoding method provided in the disclosure is disabled when the type of the current picture is a B/P picture.

Exemplarily, if the prediction type for the current block is the IBC mode, the IBC-LIC mode is enabled for the current sequence to which the current block belongs, the IBC mode for the current block is not the IBC merge mode, and the area of the current block is greater than 32, then the decoder obtains the first flag by parsing the bitstream. If the first flag indicates that the IBC-LIC mode is enabled for the current block, the decoder determines that the IBC-LIC mode is used for the current block.

In some embodiments, the method 400 may further include the following. A residual block of the current block is obtained. A reconstructed block of the current block is determined based on the residual block and the second prediction block.

Exemplarily, the decoder decodes the bitstream to obtain the residual block, and obtains the reconstructed block by adding the residual block and the second prediction block.

The main idea of this technical proposal is to provide more different models and modes for IBC-LIC.

The specific operations are as follows. Depending on a template region involved in the calculation of a linear model, a mode in which both a top template and a left template are used, a mode in which only the top template is used, and a mode in which only the left template is used may be included. Such a mode type is a template region selection mode. In addition, the classification of reconstructed samples and prediction samples according to sample values is allowed for the current coding, a linear model is calculated for each category of sample group (i.e., a reconstructed sample group or a prediction sample group), and then linear transformation is performed on prediction samples of each category according to their respective linear model. Such a mode is multi-model IBC-LIC. Furthermore, slope adjustment may also be performed on the calculated linear model, so that an adjusted linear model better matches the relationship of change between a prediction block and an original sample block. Such a mode type is a parameter adjustment mode.

For ease of description, types of the template region selection mode are marked as follows. IBC-LIC is a mode in which both a top template region and a left template region are used for the calculation of the linear model, IBC-LIC-T is a mode in which only the top template region is used for the calculation of the linear model, and IBC-LIC-L is a mode in which only the left template region is used for the calculation of the linear model.

Multi-model modes are marked as follows. IBC-LIC-M is a mode in which both the top template region and the left template region are used for the sample classification and the calculation of the linear model, IBC-LIC-MT is a mode in which only the top template region is used for the sample classification and the calculation of the linear model, and IBC-LIC-ML is a mode in which only the left template region is used for the sample classification and the calculation of the linear model.

A type of the parameter adjustment mode is marked as follows. IBC-LIC-slope indicates the adjustment on a slope of the linear model using a scaling factor or a compensation value. This type may be subdivided into more subtypes, including different modes determined according to different scaling factors or compensation values, different modes determined according to the application of this technology to a single model or a multi-model, and different modes determined according to different template regions. For example, IBC-LIC-slope0 to IBC-LIC-slope3 may indicate four types of linear model slope adjustment for IBC-LIC, and IBC-LIC-slope4 may indicate linear model slope adjustment for IBC-LIC-M, etc.

The following will give an exemplary illustration of a coding method provided in the disclosure from the perspectives of an encoder and a decoder respectively.

Based on whether to calculate a distortion cost of a linear model, the following two embodiments are provided in the coding solution of the disclosure.

### Embodiment 1

At the encoding end, for a current CU, IBC match search is performed, all IBC-LIC modes and other IBC prediction modes are tried respectively, and cost information (costPred) is calculated between a prediction block transformed using a linear model corresponding to each IBC-LIC mode and an original block corresponding to the current CU. In addition, for each IBC-LIC mode, cost information (costTemplate) is calculated between a sample in a template region transformed using the linear model and a reconstructed picture sample (or an original picture sample) in a corresponding template region, and these IBC-LIC modes are ordered according to the magnitude of costTemplate, where an IBC-LIC mode with a low cost is encoded and transmitted with fewer codewords, and an IBC-LIC mode with a high cost is encoded and transmitted with more codewords. For different IBC prediction modes, costPred is compared, and an IBC prediction mode with a low cost is selected as an optimal mode for a current coding block in an IBC AMVP mode. For the current CU, prediction modes in a merge mode are tried. First, a merge mode list is constructed, and BV information is obtained from neighbouring reference blocks, where information of the mode list further includes obtained information of prediction modes such as IBC-LIC, IBC-CIIP, IBC-GPM, and IBC-RR corresponding to the blocks. If the obtained information indicates that IBC-LIC is enabled, then for the current CU, IBC-LIC technology also needs to be used for linear transformation after a prediction block is obtained according to the BV, and an IBC-LIC mode index is also obtained through inheritance.

At the decoding end, if an IBC merge mode is used for a current decoding unit, a bitstream is parsed to obtain an index of a merge mode list, and a corresponding BV and related information are obtained according to the index. If IBC-LIC is enabled, IBC-LIC technology is also used for the current decoding unit. If IBC-LIC is disabled, the IBC-LIC technology is also not used for the current decoding unit. If the current decoding unit is in an IBC AMVP mode, the bitstream is parsed to obtain information such as a usage flag and a mode index related to IBC-LIC. For one thing, for all modes related to IBC-LIC, costTemplate is calculated in template regions. The calculation manner of costTemplate is the same as that at the encoding end, that is, cost information (costTemplate) is calculated between a sample in a template region transformed using the linear model and a reconstructed picture sample in a corresponding template region, and these modes are ordered according to the magnitude of costTemplate. For another, a final IBC-LIC mode for the current decoding unit is determined based on an IBC-LIC mode index parsed from the bitstream and information of the ordered modes. According to the determined IBC-LIC mode, a sample(s) in the corresponding template region is selected for calculating the linear model, and whether to modify linear model parameters is determined according to the IBC-LIC mode. The calculated linear model is applied to a reference block, i.e., a prediction block, which is then subject to linear transformation to generate a new prediction block.

In this embodiment, when an IBC-LIC mode in the IBC AMVP mode is used for the current CU, costTemplate of all IBC-LIC modes in the IBC AMVP mode is calculated, and all the IBC-LIC modes are ordered based on the magnitude of calculated costTemplate. Then, an optimal IBC-LIC mode among all the ordered IBC-LIC modes is indicated to the decoder via the bitstream. Accordingly, when the decoder determines that the IBC-LIC mode in the IBC AMVP mode is used for the current decoding unit, the decoder may calculate costTemplate of all the IBC-LIC modes in the IBC AMVP mode, order all the IBC-LIC modes based on the magnitude of calculated costTemplate, and decode the bitstream to determine an optimal IBC-LIC mode for the current decoding unit from all the ordered IBC-LIC modes.

### Embodiment 2

At the encoding end, for a current CU, IBC match search is performed, all IBC-LIC modes and other IBC prediction modes are tried respectively, and cost information (costPred) is calculated between a prediction block transformed using a linear model corresponding to each IBC-LIC mode and a reconstructed picture sample (or an original picture sample) corresponding to the current CU. For different IBC prediction modes, costPred is compared, and an IBC prediction mode with a low cost is selected as an optimal mode for a current coding block in an IBC AMVP mode. For the current CU, prediction modes in a merge mode are tried. First, a merge mode list is constructed, and BV information is obtained from neighbouring reference blocks, where information of the mode list further includes obtained information of prediction modes such as IBC-LIC, IBC-CIIP, IBC-GPM, and IBC-RR corresponding to the blocks. If the obtained information indicates that IBC-LIC is enabled, then for the current CU, IBC-LIC technology also needs to be used for linear transformation after a prediction block is obtained according to the BV, and an IBC-LIC mode index is also obtained through inheritance.

At the decoding end, if an IBC merge mode is used for a current decoding unit, a bitstream is parsed to obtain an index of a merge mode list, and a corresponding BV and related information are obtained according to the index. If IBC-LIC is enabled, IBC-LIC technology is also used for the current decoding unit. If IBC-LIC is disabled, the IBC-LIC technology is also not used for the current decoding unit. If the current decoding unit is in an IBC AMVP mode, the bitstream is parsed to obtain information such as a usage flag and a mode index related to IBC-LIC. According to a determined IBC-LIC mode, a sample(s) in a corresponding template region is selected for calculating a linear model, and whether to modify linear model parameters is determined according to the IBC-LIC mode. The calculated linear model is applied to a reference block, i.e., a prediction block, which is then subject to linear transformation to generate a new prediction block.

In this embodiment, when an IBC-LIC mode in the IBC AMVP mode is used for the current CU, the encoder may indicate to the decoder the information such as the usage flag and the mode index related to IBC-LIC via the bitstream. Accordingly, when the decoder determines that the IBC-LIC mode in the IBC AMVP mode is used for the current decoding unit, the decoder may decode the bitstream to determine an optimal IBC-LIC mode for the current decoding unit.

It may be noted that, the calculation process of a model corresponding to IBC-LIC in embodiments 1 and 2 above is not limited in the disclosure. For example, for the specific implementation thereof, reference can be made to the solutions described above (for example, the solutions related to the first model, the second model, the multiple third models, and the multiple fourth models), which will not be repeated herein. To control complexity and facilitate implementation, for multi-model modes such as IBC-LIC-M, only two linear models are used for transformation within a prediction block in the disclosure. Certainly, three, four, or five linear models may be used, following the same method as for the two linear models, which will not be elaborated herein.

Taking two linear models as an example, the process of IBC-LIC-M is as follows. According to an average of samples in a template region of a reference block (i.e., the first prediction block above), the samples in the template region are classified into two categories: one with sample values greater than the average of the samples in the template region, and the other with sample values less than or equal to the average of the samples in the template region. For samples in a template region of a current prediction block (i.e., the current block above), as in the first step above, the samples in the template region of the current prediction block are also correspondingly classified into two categories according to coordinates of the samples in the template region of the reference block, forming combinations. Next, for these two categories of samples, linear model parameters are calculated respectively, following the same calculation process as described above and as for the single model. For example, for ease of description, a linear model calculated for samples in one category with values greater than the average of the samples in the template region is referred to as model 1, and a linear model calculated for samples in one category with values less than or equal to the average of the samples in the template region is referred to as model 2. Then, linear transformation is performed on the reference block. In particular, a linear model may be selected according to sample values in the reference block. If the sample values are greater than the average of the samples in the template region, model 1 is used for linear transformation, and if the sample values are less than or equal to the average of the samples in the template region, model 2 is used for linear transformation, so as to obtain a prediction block (i.e., the second prediction block above) of a current CU.

It may be noted that for the selection of model 1, the sample values are not necessarily greater than the average of the samples in the template region. Alternatively, model 1 may be selected when the sample values are greater than or equal to the average of the samples in the template region, and on the contrary, model 2 is selected when the sample values are less than the average of the samples in the template region. Alternatively, model 1 may be selected when the sample values are less than or equal to the average of the samples in the template region, and on the contrary, model 2 is selected when the sample values are greater than the average of the samples in the template region. This disclosure is not limited in this regard.

Taking embodiment 1 as an example, the following will give an exemplary illustration of the specific implementation of a codec.

A basic process of an encoder is as follows.

The encoder traverses prediction modes. If a type of a current prediction mode is an IBC mode, the encoder obtains an enable flag of this technology. The flag is a sequence-level flag indicating that an IBC-LIC mode is enabled for the encoder currently, which may be, for example, in the form of sps_ibc_lic_enable_flag.

### Step 1

If an IBC-LIC enable flag is true, a region area of a current CU is greater than threshold 1, and the region area of the current CU is less than threshold 2, then the encoder tries an IBC-LIC prediction method, i.e., the encoder performs step 2. If the IBC-LIC enable flag is not true or other conditions such as a condition regarding region area are not satisfied, the encoder does not try the IBC-LIC prediction method, i.e., the encoder skips step 2 and directly performs step 3.

### Step 2

Reconstructed samples in a top template region and a left template region of the current CU and reconstructed samples in a top template region and a left template region of a reference block are obtained.

### Step 2.1

The encoding end traverses all prediction modes in an IBC AMVP mode and calculates corresponding rate-distortion cost values.

Calculation for a prediction block may be as follows. The encoding end tries all IBC-LIC related modes, determines a template region according to the IBC-LIC mode, and obtains the number of samples in a corresponding mode. If a current mode is a multi-model related mode, the samples are classified according to an average of the samples, and linear models are calculated separately. For the calculation process, reference can be made to the solutions described above. As such, scaling factors a1 and a2 and offset parameters b1 and b2 are obtained. If the current mode is not a multi-model related mode, the samples do not need to be classified, and only one linear model, i.e., a and b, needs to be calculated. If the current mode is a parameter adjustment mode, model parameters of the linear model are adjusted according to adjustment values of the scaling parameter and/or adjustment values of the offset parameter in different modes, and a new scaling factor a and a new offset parameter b are recalculated. Linear transformation is performed on the prediction block to obtain a new prediction block of the current CU.

In addition, cost calculation for the template region is as follows. According to linear parameters calculated for each IBC-LIC mode, linear transformation is performed on a prediction sample in the template region to obtain a new prediction sample, and a distortion cost is calculated between the new prediction sample and a reconstructed sample in a corresponding region, to obtain costTemplate corresponding to each IBC-LIC mode. The IBC-LIC modes are ordered according to the magnitude of costTemplate. The cost calculation for the template region is used for determining codewords required for transmission of each mode. For example, a mode with a low cost is assigned with fewer codewords for transmission, and a mode with a high cost is assigned with more codewords for transmission.

Rate-distortion cost calculation may be as follows. For each IBC-LIC mode, a residual block of the current CU is obtained according to a difference between a prediction block that is subject to linear transformation in the IBC-LIC mode and an original picture in a corresponding region. The residual block is subject to transform and quantization as well as inverse quantization and inverse transform, and then is added to the prediction block to obtain a reconstructed block. A distortion between the reconstructed block and the original picture is calculated, and index codewords and residual codewords that need to be encoded in the IBC-LIC mode are taken into consideration. A minimum rate-distortion cost costAmvp is obtained by traversing all modes.

### Step 2.2

The encoding end constructs list information for an IBC merge mode, traverses all candidate modes, and calculates corresponding rate-distortion cost values.

Specifically, for the current CU, candidate BVs in a merge list are traversed. If inherited information indicates that IBC-LIC is enabled, then for the current CU, a reference block is obtained according to the BV information. In addition, samples in neighbouring template regions of the current CU and the reference block are obtained according to an inherited IBC-LIC mode, and linear model parameters are calculated. Transform is performed on the reference block according to the linear model parameters, following the same operations as described above, to obtain a final prediction block. A residual of the current CU is obtained according to a difference between the prediction block and an original sample corresponding to the current CU. A rate-distortion cost value, represented by costIdx1, is calculated through operations including transform and quantization. By traversing other candidate BVs in the merge list, rate-distortion cost values costIdx2, costIdx3, costIdx4, and the like are calculated in the same method. The cost values such as costIdx1 and costIdx2, and the like are compared, and a minimum cost value is recorded as costMerge.

### Step 3

The encoding end traverses other prediction technologies, calculates a rate-distortion cost value corresponding to each prediction mode, and selects a prediction mode corresponding to a minimum cost value as an optimal prediction mode for the current CU.

Specifically, if costAmvp is the minimum, an IBC-LIC mode in the AMVP mode is used for the current CU. In this case, a CU-level usage flag (i.e., the first flag above) of IBC-LIC needs to be set to true and signalled into a bitstream, and an index (i.e., the first index above) of the IBC-LIC mode also needs to be signalled into the bitstream. If costMergeIbc is the minimum, an IBC-LIC mode in the merge mode is used for the current CU. In this case, for IBC, a merge flag (i.e., the second flag above) is set to true and signalled into the bitstream, and a merge index is also signalled into the bitstream. If illuminance compensation technology is enabled for the current CU and costLic is not the minimum, the illuminance compensation technology is not used for the current CU. A CU-level usage flag of the illuminance compensation technology needs to be set to false and signalled into the bitstream. Otherwise, other information such as an optimal prediction mode is signalled into the bitstream. Since it is not strongly correlated with this technology, details are not described herein.

### Step 4

After all CUs are traversed, a bitstream is output after in-loop filtering, entropy coding, or other technologies.

Accordingly, a basic process of a decoder is as follows.

The decoding end parses or obtains an lic enable flag. The flag is a sequence-level flag (sps_ibc_lic_enable_flag) indicating that the IBC-LIC technology is enabled for the decoder currently.

### Step 1

A bitstream is parsed to obtain a prediction type for a current CU. If the prediction type for the current CU is an IBC mode, a merge usage flag of the current CU is parsed. If the merge usage flag of the current CU is not true, sps_ibc_lic_enable_flag is true, a region area of the current CU is greater than threshold 1, and the region area of the current CU is less than threshold 2, then the bitstream is parsed to obtain an IBC-LIC usage flag (cu_ibc_lic_flag). If the IBC-LIC usage flag is true, an IBC-LIC mode index (cu_ibc_lic_index) is further parsed.

If the usage flag cu_ibc_lic_flag of the current CU is false, step 3 is performed.

If the merge usage flag is currently true, a merge index is parsed, and corresponding IBC-LIC information is obtained according to the parsed merge index. If an inherited IBC-LIC usage flag is true, step 2 is performed according to an inherited IBC-LIC mode index. Otherwise, step 3 is performed.

### Step 2

If an AMVP mode is currently used, cost calculation for a template region is performed. According to linear parameters calculated for each IBC-LIC mode, linear transformation is performed on a prediction sample in the template region to obtain a new prediction sample, and a distortion cost is calculated between the new prediction sample and a reconstructed sample in a corresponding region, to obtain costTemplate corresponding to each IBC-LIC mode. The IBC-LIC modes are ordered according to the magnitude of costTemplate. An IBC-LIC mode is determined according to a parsed IBC-LIC index and an order of the ordered IBC-LIC modes.

It may be noted that, after the IBC-LIC modes are ordered according to the magnitude of costTemplate, an ordered list may be obtained, so that the decoder can find a corresponding IBC-LIC mode in the ordered mode list according to an index and then perform prediction on the current CU. Certainly, the concept of a list may also be not introduced, and this disclosure is not limited in this regard.

If a merge mode is used, an IBC-LIC mode is determined according to a parsed IBC-LIC mode index.

### Calculation for a Prediction Block

According to the IBC-LIC mode, reconstructed samples in a neighbouring template region of the current CU are obtained, and reconstructed samples in a neighbouring template region of a reference CU are also obtained.

If a single-model mode is used, the obtained reconstructed samples are modeled using the linear model calculation method described above, and a scaling factor a and an offset parameter b are calculated. Linear transformation is performed on the prediction block, with transformation parameters including scaling by a times and compensating by b. A new prediction block is obtained through linear transformation on the prediction block.

If a multi-model mode is used, samples in two template regions are classified according to an average of samples in a neighbouring template region of a reference block. In the neighbouring template region of the reference block, samples with sample values greater than the average of the samples are classified into the first category, and accordingly, samples at corresponding positions in a neighbouring template region of the prediction block are also classified into the first category. On the contrary, in the neighbouring template region of the reference block, samples with sample values less than or equal to the average of the samples are classified into the second category, and similarly, samples at corresponding positions in the neighbouring template region of the prediction block are also classified into the second category. Using the above model calculation method, a linear model for the first category and a linear model for the second category are calculated for samples of the first category and samples of the second category, respectively. Model parameters of the linear model for the first category include a scaling parameter a1 and an offset parameter b1, and model parameters of the linear model for the second category include a scaling parameter a2 and an offset parameter b2. The linear model for the first category or the linear model for the second category is selected according to the magnitude relationship between sample values in the reference block and the average of the samples in the template region. A new prediction block is obtained by using the linear model for the first category for linear transformation on samples in the reference block with the sample values greater than the average of the samples in the template region, and on the contrary, using the linear model for the second category for linear transformation on samples in the reference block with the sample values less than or equal to the average of the samples in the template region.

If a parameter adjustment mode is used, a slope of a linear model is adjusted according to an adjustment value of a scaling parameter and/or an adjustment value of an offset parameter corresponding to the parameter adjustment mode, to obtain a new scaling factor a and a new offset parameter b. Then, linear transformation is performed on the prediction block to obtain a new prediction block.

### Step 3

Information such as a usage flag or an index of the technology is further parsed, and a final prediction block of the current CU is derived according to the parsed information.

### Step 4

The bitstream is parsed to obtain residual information, and time-domain residual information is obtained through inverse quantization and inverse transform. A reconstructed sample block is obtained by adding the final prediction block and the time-domain residual information.

### Step 5

After all reconstructed sample blocks are processed by in-loop filtering or other technologies, a final reconstructed picture is obtained, which can be implemented as a video output or as a reference for subsequent decoding.

It may be noted that in the above embodiments, the use of IBC-LIC at the CU level is limited. If a product of a width and a height of the current CU is less than 32 or greater than 256, the illuminance compensation technology is disabled. That is, threshold 1 is 32, and threshold 2 is 256. However, this limitation may be modified according to the coupling between various technologies. For example, in this embodiment, the limitation that IBC-LIC cannot be used for a CU with a product of a width and a height less than 32 may be used, and there is no limitation for a large area.

The following will give an exemplary illustration of syntax elements involved in the disclosure.

The following is a CU-level syntax element parsing table. Bold means that the syntax element needs to be parsed. For example, cu_ibc_lic_flag is a CU-level syntax element that needs to be parsed.

TABLE 2

| | |
|---|---|
| if (sps_ibc_lic_enable_flag && modeType == | |
| MODE_IBC && !merge_flag && cbWidth * | |
| cbHeight >32) { | |
| cu_{—}ibc_{—}lic_{—}flag | ae(v) |
| if (cu_ibc_lic_flag) | |
| cu_{—}ibc_{—}lic_{—}index | ae(v) |
| } | |
| else { | |
| cu_ibc_lic_flag = 0 | |
| } | |

In the above, sps_ibc_lic_enable_flag is a sequence-level illuminance compensation enable flag, cu_ibc_lic_flag is an IBC-LIC usage flag of a current CU, and cu_ibc_lic_index is an IBC-LIC index of the current CU. Before cu_ibc_lic_flag and cu_ibc_lic_index are parsed, a bitstream has been parsed to obtain a corresponding value of each of the following syntax elements. Herein, modeType is a prediction type for the current CU, which may be MODE_INTRA indicating intra prediction, MODE_INTER indicating inter prediction, or MODE IBC indicating IBC prediction. merge_flag is a merge usage flag of the current CU. cbWidth and cbHeight are a width and a height of a current coding block (CB), respectively.

The logic of parsing the syntax elements illustrated in Table 2 is as follows.

If an IBC-LIC mode is enabled for a current sequence to which a current block belongs, a prediction type for the current block is an IBC mode, the IBC mode for the current block is not an IBC merge mode, and an area of the current block is greater than 32, then cu_ibc_lic_flag is obtained by parsing the bitstream. If a value of cu_ibc_lic_flag is a first value (for example, 0), it is determined that the IBC-LIC mode is not used for the current block. If the value of cu_ibc_lic_flag is a second value (for example, 1), it is determined that the IBC-LIC mode is used for the current block. Further, when the value of cu_ibc_lic_flag is the second value (for example, 1), a decoder parses cu_ibc_lic_index, where cu_ibc_lic_index indicates a prediction mode for the current block.

It may be noted that, a condition for parsing cu_ibc_lic_flag may be determined according to the coupling with an existing coding tool in standards. That is, if another IBC-type prediction technology is enabled for the current CU and cannot be used concurrently with IBC-LIC, a CU-level usage flag of the foregoing technology may be first parsed to determine whether to parse the IBC-LIC usage flag of the current CU. If a CU usage flag of the foregoing tool is true, the IBC-LIC usage flag of the current CU does not need to be parsed, or otherwise, the IBC-LIC usage flag of the current CU is parsed.

Exemplarily, if the IBC-LIC mode is enabled for the current sequence to which the current block belongs, the prediction type for the current block is the IBC mode, the IBC mode for the current block is not the IBC merge mode, the area of the current block is greater than 32, and the IBC mode for the current block is not a mode of a type that is not used concurrently with the IBC-LIC mode, then the decoder obtains cu_ibc_lic_flag by parsing the bitstream. If the value of cu_ibc_lic_flag is a first value (for example, 0), the decoder determines that the IBC-LIC mode is not used for the current block. If the value of cu_ibc_lic_flag is a second value (for example, 1), the decoder determines that the IBC-LIC mode is used for the current block. Further, when the value of cu_ibc_lic_flag is the second value (for example, 1), the decoder parses cu_ibc_lic_index, where cu_ibc_lic_index indicates a prediction mode for the current block.

Taking reconstruction-reordered IBC (RRIBC) as an example, the syntax element table illustrated as Table 2 may be updated to a syntax element table illustrated as Table 3. RRIBC is a technology in which reconstructed samples are reordered and then a matching block(s) is searched. The reordering operation includes, but is not limited to, horizontal flipping and vertical flipping.

TABLE 3

| | |
|---|---|
| if (sps_ibc_lic_enable_flag && modeType == | |
| MODE_IBC && !merge_flag && cbWidth * | |
| cbHeight >32&& cu_rribc_flip_type == 0) { | |
| cu_{—}ibc_{—}lic_{—}flag | ae(v) |
| if (cu_ibc_lic_flag) | |
| cu_{—}ibc_{—}lic_{—}index | ae(v) |
| } | |
| else { | |
| cu_ibc_lic_flag = 0 | |
| } | |

In the above, cu_rribc_flip_type is an operation type of the RRIBC technology. If cu_rribc_flip_type is 0, it indicates that the RRIBC technology is not used for the current CU. Otherwise, it indicates that the RRIBC technology is used for the current CU, and a value of cu_rribc_flip_type is an index of the operation type. It may be understood that, Table 3 only illustrates the syntax-parsing correlation between the tool RRIBC and IBC-LIC. Similarly, another IBC coding tool also has such a relationship, which will not be repeated herein.

The logic of parsing the syntax elements illustrated in Table 3 is as follows.

If the IBC-LIC mode is enabled for the current sequence to which the current block belongs, the prediction type for the current block is the IBC mode, the IBC mode for the current block is not the IBC merge mode, the area of the current block is greater than 32, and the IBC mode for the current block is not a mode of an RRIBC type, then cu_ibc_lic_flag is obtained by parsing the bitstream. If a value of cu_ibc_lic_flag is a first value (for example, 0), it is determined that the IBC-LIC mode is not used for the current block. If the value of cu_ibc_lic_flag is a second value (for example, 1), it is determined that the IBC-LIC mode is used for the current block. Further, when the value of cu_ibc_lic_flag is the second value (for example, 1), the decoder parses cu_ibc_lic_index, where cu_ibc_lic_index indicates a prediction mode for the current block.

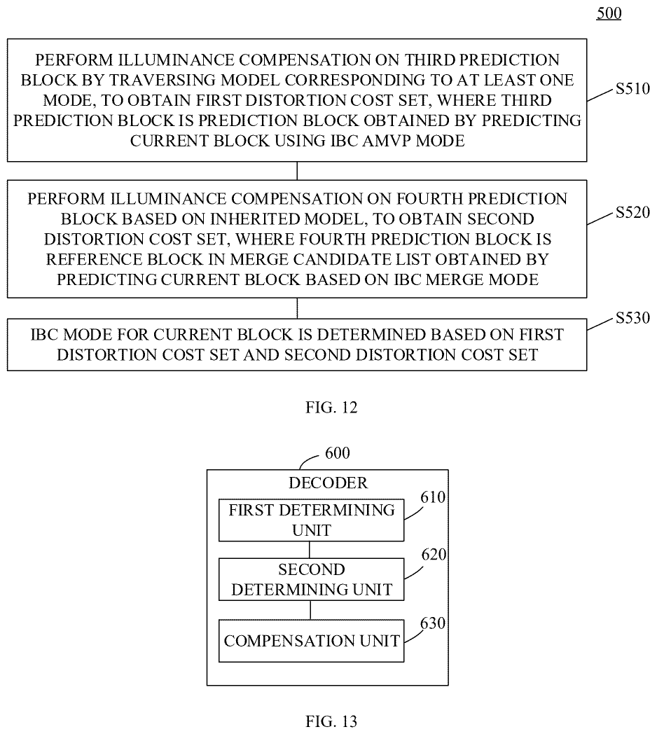

An encoding method of embodiments of the disclosure will be described below from the perspective of an encoder with reference to FIG. 12.

FIG. 12 is a schematic flowchart of an encoding method 500 provided in the disclosure.

It may be understood that, the encoding method 500 may be performed by an encoder. For example, the encoding method 500 may be performed by the video encoder 112 illustrated in FIG. 1 or the video encoder 200 illustrated in FIG. 2.

As illustrated in FIG. 12, the encoding method 500 may include the following.

At S510, illuminance compensation is performed on a third prediction block by traversing a model corresponding to at least one mode, to obtain a first distortion cost set, where the third prediction block is a prediction block obtained by predicting a current block using an IBC AMVP mode.

At S520, illuminance compensation is performed on a fourth prediction block based on an inherited model, to obtain a second distortion cost set, where the fourth prediction block is a reference block in a merge candidate list obtained by predicting the current block based on an IBC merge mode.

At S530, an IBC mode for the current block is determined based on the first distortion cost set and the second distortion cost set.

In some embodiments, operations at S530 may include the following. If a minimum value in the first distortion cost set is less than a minimum value in the second distortion cost set and a distortion cost of the current block in another prediction mode, it is determined that the IBC mode for the current block is the IBC AMVP mode.

In some embodiments, the method 500 may further include the following. A first flag is determined, where the first flag indicates that an IBC-LIC mode is enabled for the current block. The first flag is encoded.

In some embodiments, the method 500 may further include the following. A first index is determined, where the first index indicates a first prediction mode used for the current block in the at least one mode. The first index is encoded.

In some embodiments, the first index indicates the first prediction mode in the ordered at least one mode. The method 500 may further include the following. A distortion cost of the at least one mode is determined, where a distortion cost of any mode in the at least one mode is determined based on a reconstructed sample in a template region of the current block and a sample obtained by performing illuminance compensation on at least one prediction sample using a model corresponding to the any mode, and the at least one prediction sample includes a prediction sample obtained by predicting a sample in the template region of the current block using the IBC-LIC mode. The ordered at least one mode is obtained by ordering the at least one mode based on the distortion cost of the at least one mode.

In some embodiments, the method 500 may further include the following. A first model is determined based on a reconstructed sample in a template region of the current block and a reconstructed sample in a template region of the third prediction block. The at least one mode includes a first mode corresponding to the first model.

In some embodiments, the method 500 may further include the following. A second model is obtained by adjusting a parameter of the first model based on an adjustment value corresponding to the first mode. The at least one mode includes a second mode corresponding to the second model.

In some embodiments, the method 500 may further include the following. Multiple third models are determined. Any one of the multiple third models is determined based on a first sample group obtained by partitioning reconstructed samples in a template region of the current block and a second sample group obtained by partitioning prediction samples in a template region of the third prediction block, and the at least one mode includes a third mode corresponding to the multiple third models.

In some embodiments, the method 500 may further include the following. Multiple fourth models are obtained by adjusting parameters of the multiple third models based on an adjustment value corresponding to the third mode. The at least one mode includes a fourth mode corresponding to the multiple fourth models.

In some embodiments, the method 500 may further include the following. Reconstructed samples in the template region of the third prediction block are partitioned into multiple sample groups based on values of the reconstructed samples in the template region of the third prediction block, where the second sample group is any one of the multiple sample groups. Reconstructed samples with positions corresponding to the second sample group in the template region of the current block are partitioned into the first sample group.

In some embodiments, an average of the reconstructed samples in the template region of the third prediction block is determined. The reconstructed samples in the template region of the third prediction block are partitioned into the multiple sample groups based on the average. The multiple sample groups include a sample group in which values of reconstructed samples are greater than or equal to the average and a sample group in which values of reconstructed samples are less than the average.

In some embodiments, an adjustment parameter includes an adjustment amount of a scaling parameter and/or an adjustment amount of an offset parameter.

In some embodiments, the template region of the current block includes a top template region and/or a left template region.

In some embodiments, a sampling step used when the template region of the current block is the top template region or the left template region is less than a sampling step used when the template region of the current block includes the top template region and the left template region. A sample obtained in the template region of the current block according to the sampling step is used for determining a model corresponding to a mode in the at least one mode.

In some embodiments, the number of sample rows of the top template region when the template region of the current block is the top template region is greater than the number of sample rows of the top template region when the template region of the current block includes the top template region and the left template region, and/or the number of sample columns of the top template region when the template region of the current block is the top template region is greater than the number of sample columns of the top template region when the template region of the current block includes the top template region and the left template region.

In some embodiments, the number of sample rows of the left template region when the template region of the current block is the left template region is greater than the number of sample rows of the left template region when the template region of the current block includes the top template region and the left template region, and/or the number of sample columns of the left template region when the template region of the current block is the left template region is greater than the number of sample columns of the left template region when the template region of the current block includes the top template region and the left template region.

In some embodiments, the method 500 may further include the following. At least one of the following indexes is encoded: an index indicating whether a model corresponding to a first prediction mode used for the current block is a single model or a multi-model, an index indicating a template region for the model corresponding to the first prediction mode, an index indicating whether the model corresponding to the first prediction mode is a parameter-adjusted model, or an adjustment parameter corresponding to the first prediction mode.

In some embodiments, the operations at S530 may include the following. If a minimum value in the second distortion cost set is less than a minimum value in the first distortion cost set and a distortion cost of the current block in another prediction mode, it is determined that the IBC mode for the current block is the IBC merge mode.

In some embodiments, the method 500 may further include the following. The merge candidate list is constructed. A second index is determined, where the second index indicates a BV from the current block to a first reference block in the merge candidate list. The second index is encoded.

In some embodiments, the method 500 may further include the following. A second flag is determined, where the second flag indicates whether the IBC mode for the current block is the IBC merge mode. The second flag is encoded.

In some embodiments, operations at S510 may include the following. If at least one of the following conditions is satisfied, illuminance compensation is performed on the third prediction block based on the model corresponding to the at least one mode, to obtain the first distortion cost set. A prediction type for the current block is the IBC mode. An IBC-LIC mode is enabled for a current sequence to which the current block belongs. An area of the current block is greater than or equal to a preset first threshold. The area of the current block is less than or equal to a preset second threshold. A type of a current picture to which the current block belongs is a preset type. The IBC mode for the current block is not a mode of a type that is not used concurrently with the IBC-LIC mode.

In some embodiments, operations at S520 may include the following. The merge candidate list is constructed. For a first candidate reference block in the merge candidate list, if an IBC-LIC mode is used for the first candidate reference block, the second distortion cost set includes a distortion cost obtained by performing illuminance compensation on the first candidate reference block based on a model for the first candidate reference block.

It may be understood that, the encoding method may be understood as an inverse process of the decoding method. Therefore, for the specific solutions of the encoding method 500, reference can be made to related contents of the decoding method 400, which will not be repeated herein for simplicity.

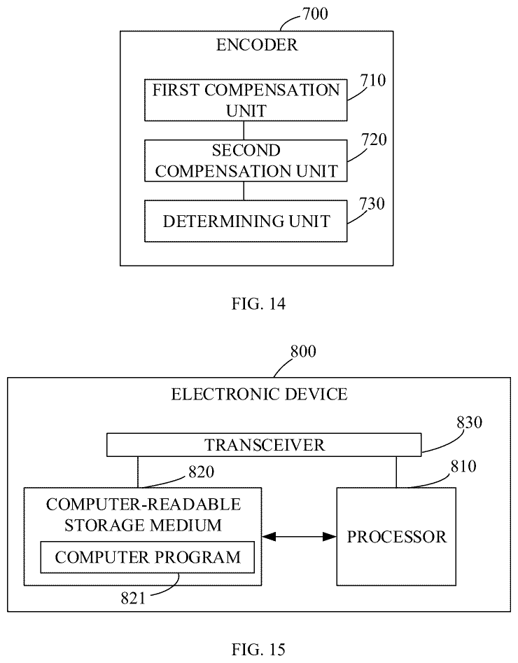

The method embodiments of the disclosure are described in detail above, and apparatus embodiments of the disclosure will be described in detail below with reference to FIG. 13 to FIG. 14.

FIG. 13 is a schematic block diagram of a decoder 600 provided in the disclosure.

As illustrated in FIG. 13, the decoder 600 may include a first determining unit 610, a second determining unit 620, and a compensation unit 630. The first determining unit 610 is configured to determine whether an IBC-LIC mode is used for a current block. The second determining unit 620 is configured to determine a first prediction mode used for the current block in the IBC-LIC mode, if the IBC-LIC mode is used for the current block. The compensation unit 630 is configured to perform, based on a model corresponding to the first prediction mode, illuminance compensation on a first prediction block obtained by predicting the current block using an IBC mode for the current block, to obtain a second prediction block of the current block.

In some embodiments, the second determining unit 620 is specifically configured to decode a bitstream to determine a first index. The first index indicates the first prediction mode in at least one mode.

In some embodiments, the first index indicates the first prediction mode in the ordered at least one mode. The second determining unit 620 is further configured to determine a distortion cost of the at least one mode, where a distortion cost of any mode in the at least one mode is determined based on a reconstructed sample in a template region of the current block and a sample obtained by performing illuminance compensation on at least one prediction sample using a model corresponding to the any mode, and the at least one prediction sample includes a prediction sample obtained by predicting a sample in the template region of the current block using the IBC-LIC mode. The second determining unit 620 is further configured to obtain the ordered at least one mode by ordering the at least one mode based on the distortion cost of the at least one mode.

In some embodiments, the second determining unit 620 is further configured to determine a first model based on a reconstructed sample in a template region of the current block and a reconstructed sample in a template region of the first prediction block. The at least one mode includes a first mode corresponding to the first model.

In some embodiments, the second determining unit 620 is further configured to obtain a second model by adjusting a parameter of the first model based on an adjustment value corresponding to the first mode. The at least one mode includes a second mode corresponding to the second model.

In some embodiments, the second determining unit 620 is further configured to determine multiple third models. Any one of the multiple third models is determined based on a first sample group obtained by partitioning reconstructed samples in a template region of the current block and a second sample group obtained by partitioning prediction samples in a template region of the first prediction block, and the at least one mode includes a third mode corresponding to the multiple third models.

In some embodiments, the second determining unit 620 is further configured to obtain multiple fourth models by adjusting parameters of the multiple third models based on an adjustment value corresponding to the third mode. The at least one mode includes a fourth mode corresponding to the multiple fourth models.

In some embodiments, the second determining unit 620 is further configured to partition reconstructed samples in the template region of the first prediction block into multiple sample groups based on values of the reconstructed samples in the template region of the first prediction block, where the second sample group is any one of the multiple sample groups. The second determining unit 620 is further configured to partition reconstructed samples with positions corresponding to the second sample group in the template region of the current block into the first sample group.

In some embodiments, the second determining unit 620 is specifically configured to determine an average of the reconstructed samples in the template region of the first prediction block, and partition the reconstructed samples in the template region of the first prediction block into the multiple sample groups based on the average. The multiple sample groups include a sample group in which values of reconstructed samples are greater than or equal to the average and a sample group in which values of reconstructed samples are less than the average.

In some embodiments, an adjustment parameter includes an adjustment amount of a scaling parameter and/or an adjustment amount of an offset parameter.

In some embodiments, the template region of the current block includes a top template region and/or a left template region.

In some embodiments, a sampling step used when the template region of the current block is the top template region or the left template region is less than a sampling step used when the template region of the current block includes the top template region and the left template region. A sample obtained in the template region of the current block according to the sampling step is used for determining a model corresponding to a mode in the at least one mode.

In some embodiments, the number of sample rows of the top template region when the template region of the current block is the top template region is greater than the number of sample rows of the top template region when the template region of the current block includes the top template region and the left template region, and/or the number of sample columns of the top template region when the template region of the current block is the top template region is greater than the number of sample columns of the top template region when the template region of the current block includes the top template region and the left template region.

In some embodiments, the number of sample rows of the left template region when the template region of the current block is the left template region is greater than the number of sample rows of the left template region when the template region of the current block includes the top template region and the left template region, and/or the number of sample columns of the left template region when the template region of the current block is the left template region is greater than the number of sample columns of the left template region when the template region of the current block includes the top template region and the left template region.

In some embodiments, the second determining unit 620 is further configured to decode a bitstream to determine at least one index, where the at least one index includes at least one of: an index indicating whether the model corresponding to the first prediction mode is a single model or a multi-model, an index indicating a template region for the model corresponding to the first prediction mode, an index indicating whether the model corresponding to the first prediction mode is a parameter-adjusted model, or an adjustment parameter corresponding to the first prediction mode. The second determining unit 620 is further configured to determine the first prediction mode based on the at least one index.

In some embodiments, the first determining unit 610 is specifically configured to decode a bitstream to determine a first flag, if the IBC mode for the current block is an IBC AMVP mode. The first determining unit 610 is specifically configured to determine that the IBC-LIC mode is used for the current block, if the first flag indicates that the IBC-LIC mode is enabled for the current block.

In some embodiments, the first determining unit 610 is specifically configured to construct a merge candidate list, if the IBC mode for the current block is an IBC merge mode. The first determining unit 610 is specifically configured to determine a second index, where the second index indicates a BV from the current block to a first reference block of the current block in the merge candidate list. The first determining unit 610 is specifically configured to determine that the IBC-LIC mode is used for the current block, if the IBC-LIC mode is used for the first reference block.

In some embodiments, the second determining unit 620 is specifically configured to determine a prediction mode for the first reference block as the first prediction mode.

In some embodiments, the first determining unit 610 is further configured to obtain a second flag, before determining whether the IBC-LIC mode is used for the current block. The second flag indicates whether the IBC mode for the current block is an IBC merge mode.

In some embodiments, the compensation unit 630 is specifically configured to perform illuminance compensation on a prediction sample in the first prediction block based on a single model, to obtain the second prediction block, if the first prediction mode corresponds to the single model.

In some embodiments, the compensation unit 630 is specifically configured to determine a model for any prediction sample in the first prediction block from multiple models, if the first prediction mode corresponds to the multiple models. The compensation unit 630 is specifically configured to perform illuminance compensation on the any prediction sample based on the model for the any prediction sample, to obtain the second prediction block.

In some embodiments, the compensation unit 630 is specifically configured to determine a model corresponding to a range of a value of the any prediction sample among the multiple models as the model for the any prediction sample.

In some embodiments, the first determining unit 610 is specifically configured to determine whether the IBC-LIC mode is used for the current block, if at least one of the following conditions is satisfied. A prediction type for the current block is the IBC mode. The IBC-LIC mode is enabled for a current sequence to which the current block belongs. An area of the current block is greater than or equal to a preset first threshold. The area of the current block is less than or equal to a preset second threshold. A type of a current picture to which the current block belongs is a preset type. The IBC mode for the current block is not a mode of a type that is not used concurrently with the IBC-LIC mode.

In some embodiments, the compensation unit 630 is further configured to obtain a residual block of the current block, and determine a reconstructed block of the current block based on the residual block and the second prediction block.

It may be understood that, the apparatus embodiments of the decoder and the method embodiments of the decoding method may correspond to each other, and for similar descriptions, reference can be made to the method embodiments. To avoid repetition, details are not repeated herein. Specifically, the decoder 600 illustrated in FIG. 13 can correspond to a corresponding entity for implementing the decoding method 400 in embodiments of the disclosure, and the foregoing and other operations and/or functions of various units in the decoder 600 are respectively intended to implement corresponding processes in the decoding method 400.

FIG. 14 is a schematic block diagram of an encoder 700 provided in the disclosure.

As illustrated in FIG. 14, the encoder 700 may include a first compensation unit 710, a second compensation unit 720, and a determining unit 730. The first compensation unit 710 is configured to perform illuminance compensation on a third prediction block by traversing a model corresponding to at least one mode, to obtain a first distortion cost set, where the third prediction block is a prediction block obtained by predicting a current block using an IBC AMVP mode. The second compensation unit 720 is configured to perform illuminance compensation on a fourth prediction block based on an inherited model, to obtain a second distortion cost set, where the fourth prediction block is a reference block in a merge candidate list obtained by predicting the current block based on an IBC merge mode. The determining unit 730 is configured to determine an IBC mode for the current block based on the first distortion cost set and the second distortion cost set.

In some embodiments, the determining unit 730 is specifically configured to determine that the IBC mode for the current block is the IBC AMVP mode, if a minimum value in the first distortion cost set is less than a minimum value in the second distortion cost set and a distortion cost of the current block in another prediction mode.

In some embodiments, the determining unit 730 is further configured to: determine a first flag, where the first flag indicates that an IBC-LIC mode is enabled for the current block; and encode the first flag.

In some embodiments, the determining unit 730 is further configured to: determine a first index, where the first index indicates a first prediction mode used for the current block in the at least one mode; and encode the first index.

In some embodiments, the first index indicates the first prediction mode in the ordered at least one mode. The determining unit 730 is further configured to determine a distortion cost of the at least one mode, where a distortion cost of any mode in the at least one mode is determined based on a reconstructed sample in a template region of the current block and a sample obtained by performing illuminance compensation on at least one prediction sample using a model corresponding to the any mode, and the at least one prediction sample includes a prediction sample obtained by predicting a sample in the template region of the current block using the IBC-LIC mode. The determining unit 730 is further configured to obtain the ordered at least one mode by ordering the at least one mode based on the distortion cost of the at least one mode.

In some embodiments, the determining unit 730 is further configured to determine a first model based on a reconstructed sample in a template region of the current block and a reconstructed sample in a template region of the third prediction block. The at least one mode includes a first mode corresponding to the first model.

In some embodiments, the determining unit 730 is further configured to obtain a second model by adjusting a parameter of the first model based on an adjustment value corresponding to the first mode. The at least one mode includes a second mode corresponding to the second model.

In some embodiments, the determining unit 730 is further configured to determine multiple third models. Any one of the multiple third models is determined based on a first sample group obtained by partitioning reconstructed samples in a template region of the current block and a second sample group obtained by partitioning prediction samples in a template region of the third prediction block, and the at least one mode includes a third mode corresponding to the multiple third models.

In some embodiments, the determining unit 730 is further configured to obtain multiple fourth models by adjusting parameters of the multiple third models based on an adjustment value corresponding to the third mode. The at least one mode includes a fourth mode corresponding to the multiple fourth models.

In some embodiments, the determining unit 730 is further configured to partition reconstructed samples in the template region of the third prediction block into multiple sample groups based on values of the reconstructed samples in the template region of the third prediction block, where the second sample group is any one of the multiple sample groups. The determining unit 730 is further configured to partition reconstructed samples with positions corresponding to the second sample group in the template region of the current block into the first sample group.

In some embodiments, the determining unit 730 is specifically configured to determine an average of the reconstructed samples in the template region of the third prediction block, and partition the reconstructed samples in the template region of the third prediction block into the multiple sample groups based on the average. The multiple sample groups include a sample group in which values of reconstructed samples are greater than or equal to the average and a sample group in which values of reconstructed samples are less than the average.

In some embodiments, an adjustment parameter includes an adjustment amount of a scaling parameter and/or an adjustment amount of an offset parameter.

In some embodiments, the template region of the current block includes a top template region and/or a left template region.

In some embodiments, a sampling step used when the template region of the current block is the top template region or the left template region is less than a sampling step used when the template region of the current block includes the top template region and the left template region. A sample obtained in the template region of the current block according to the sampling step is used for determining a model corresponding to a mode in the at least one mode.

In some embodiments, the number of sample rows of the top template region when the template region of the current block is the top template region is greater than the number of sample rows of the top template region when the template region of the current block includes the top template region and the left template region, and/or the number of sample columns of the top template region when the template region of the current block is the top template region is greater than the number of sample columns of the top template region when the template region of the current block includes the top template region and the left template region.

In some embodiments, the number of sample rows of the left template region when the template region of the current block is the left template region is greater than the number of sample rows of the left template region when the template region of the current block includes the top template region and the left template region, and/or the number of sample columns of the left template region when the template region of the current block is the left template region is greater than the number of sample columns of the left template region when the template region of the current block includes the top template region and the left template region.

In some embodiments, the determining unit 730 is further configured to encode at least one of the following indexes: an index indicating whether a model corresponding to a first prediction mode used for the current block is a single model or a multi-model, an index indicating a template region for the model corresponding to the first prediction mode, an index indicating whether the model corresponding to the first prediction mode is a parameter-adjusted model, or an adjustment parameter corresponding to the first prediction mode.

In some embodiments, the determining unit 730 is specifically configured to determine that the IBC mode for the current block is the IBC merge mode, if a minimum value in the second distortion cost set is less than a minimum value in the first distortion cost set and a distortion cost of the current block in another prediction mode.

In some embodiments, the determining unit 730 is further configured to: construct the merge candidate list; determine a second index, where the second index indicates a BV from the current block to a first reference block in the merge candidate list; and encode the second index.

In some embodiments, the determining unit 730 is further configured to: determine a second flag, where the second flag indicates whether the IBC mode for the current block is the IBC merge mode; and encode the second flag.

In some embodiments, the first compensation unit 710 is specifically configured to perform illuminance compensation on the third prediction block based on the model corresponding to the at least one mode, to obtain the first distortion cost set, if at least one of the following conditions is satisfied. A prediction type for the current block is the IBC mode. An IBC-LIC mode is enabled for a current sequence to which the current block belongs. An area of the current block is greater than or equal to a preset first threshold. The area of the current block is less than or equal to a preset second threshold. A type of a current picture to which the current block belongs is a preset type. The IBC mode for the current block is not a mode of a type that is not used concurrently with the IBC-LIC mode.

In some embodiments, the second compensation unit 720 is specifically configured to construct the merge candidate list. For a first candidate reference block in the merge candidate list, if an IBC-LIC mode is used for the first candidate reference block, the second distortion cost set includes a distortion cost obtained by performing illuminance compensation on the first candidate reference block based on a model for the first candidate reference block.

It may be understood that, the apparatus embodiments of the encoder and the method embodiments of the encoding method may correspond to each other, and for similar descriptions, reference can be made to the method embodiments. To avoid repetition, details are not repeated herein. Specifically, the encoder 700 illustrated in FIG. 14 can correspond to a corresponding entity for implementing the encoding method 500 in embodiments of the disclosure, and the foregoing and other operations and/or functions of various units in the encoder 700 are respectively intended to implement corresponding processes in various methods such as the encoding method 500.

It may be further understood that units of the decoder 600 or the encoder 700 involved in embodiments of the disclosure are partitioned based on logical functions. In an actual implementation, a function of one unit can also be implemented by multiple units, or functions of multiple units are implemented by one unit. Even, the functions can also be cooperatively implemented by one or more other units. For example, part or all of the decoder 600 or the encoder 700 can be combined into one or several other units. For another example, one (or more) of the units of the decoder 600 or the encoder 700 can further be partitioned into multiple units of smaller functions. In this way, same operations can be implemented, and implementation of the technical effects of embodiments of the disclosure is not affected. For another example, the decoder 600 or the encoder 700 may also include other units. In an actual implementation, the functions can also be cooperatively implemented by other units, and can be cooperatively implemented by multiple units.

According to another embodiment of the disclosure, computer programs (including program codes) that can perform the operations involved in the corresponding method can be run on a general computing device such as a general computer, which includes processing elements and storage elements such as a central processing unit (CPU), a random access memory (RAM), and a read-only memory (ROM), to construct the decoder 600 or the encoder 700 involved in embodiments of the disclosure and implement the encoding method or the decoding method provided in embodiments of the disclosure. The computer programs can be recorded in, for example, a computer-readable storage medium, and can be loaded into any electronic device through the computer-readable storage medium, and run in the electronic device, to implement the corresponding method in embodiments of the disclosure. In other words, the units mentioned above can be implemented in the form of hardware, can be implemented by instructions in the form of software, or can be implemented in the form of a combination of software and hardware. Specifically, the operations of the method embodiments in embodiments of the disclosure can be completed by a hardware integrated logical circuit in a processor, and/or by using instructions in the form of software. The operations of the methods disclosed with reference to embodiments of the disclosure can be directly performed and completed by using a hardware decoding processor, or can be performed and completed by using a combination of hardware and software in the decoding processor. Optionally, the software can be located in a mature storage medium in the field, such as a random access memory, a flash memory, a read-only memory, a programmable read-only memory, an electrically-erasable programmable memory, or a register. The storage medium is located in the memory. The processor reads information in the memory and completes the operations of the foregoing method embodiments in combination with hardware thereof.

FIG. 15 is a schematic structural diagram of an electronic device provided in the disclosure.

As illustrated in FIG. 15, the electronic device 800 at least includes a processor 810 and a computer-readable storage medium 820. The processor 810 and the computer-readable storage medium 820 can be connected to each other through a bus or in another manner. The computer-readable storage medium 820 is configured to store computer programs 821 and the computer programs 821 include computer instructions, and the processor 810 is configured to execute the computer instructions stored in the computer-readable storage medium 820. The processor 810 is the computing core and control core of the electronic device 800. The processor 810 is adapted to implement one or more computer instructions, and is adapted to load and execute the one or more computer instructions to implement a corresponding method procedure or a corresponding function.

Exemplarily, the processor 810 may also be called a CPU. The processor 810 includes but is not limited to: a general processor, a digital signal processor (DSP), an application-specific integrated circuit (ASIC), a field programmable gate array (FPGA), or another programmable logic device, a discrete gate, a transistor logic device, or a discrete hardware component.

Exemplarily, the computer-readable storage medium 820 may be a high-speed RAM memory, or may be a non-volatile memory, such as at least one magnetic disk memory. Optionally, the computer-readable storage medium 820 may be at least one computer-readable storage medium far away from the processor 810. Specifically, the computer-readable storage medium 820 includes, but is not limited to, a volatile memory and/or a non-volatile memory. The non-volatile memory may be an ROM, a programmable read-only memory (PROM), an erasable programmable read-only memory (EPROM), an electrically erasable programmable read-only memory (EEPROM), or a flash memory. The volatile memory may be an RAM, used as an external cache. Through exemplary but not limitative description, many forms of RAMs can be used, for example, a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchronous link dynamic random access memory (synch link DRAM, SLDRAM), and a direct Rambus dynamic random access memory (direct Rambus RAM, DR RAM).

Exemplarily, the electronic device 800 may be the decoder or the decoding framework involved in embodiments of the disclosure. The computer-readable storage medium 820 stores a second computer instruction. The second computer instruction stored in the computer-readable storage medium 820 is loaded and executed by the processor 810, to implement corresponding operations in the decoding method provided in embodiments of the disclosure. In other words, the second computer instruction in the computer-readable storage medium 820 is loaded and executed by the processor 810 to perform corresponding operations. To avoid repetition, details are not repeated herein.

Exemplarily, the electronic device 800 may be the encoder or the encoding framework involved in embodiments of the disclosure. The computer-readable storage medium 820 stores a first computer instruction. The first computer instruction stored in the computer-readable storage medium 820 is loaded and executed by the processor 810, to implement corresponding operations in the encoding method provided in embodiments of the disclosure. In other words, the first computer instruction in the computer-readable storage medium 820 is loaded and executed by the processor 810 to perform corresponding operations. To avoid repetition, details are not repeated herein.

According to another aspect of the disclosure, a coding system is further provided in the disclosure. The coding system includes the decoder and the encoder.

According to another aspect of the disclosure, a computer-readable storage medium (e.g., memory) is further provided in the disclosure. The computer-readable storage medium is a memory device in the electronic device 800, and is configured to store programs and data. For example, the computer-readable storage medium is the computer-readable storage medium 820. It may be understood that, the computer-readable storage medium 820 herein may include an internal storage medium in the electronic device 800, and may also include an extended storage medium supported by the electronic device 800. The computer-readable storage medium provides a storage space, and the storage space stores an operating system of the electronic device 800. In addition, the storage space further stores one or more computer instructions adapted to be loaded and executed by the processor 810, and the one or more computer instructions may be the one or more computer programs 821 (including program codes).

According to another aspect of the disclosure, a computer program product or a computer program is further provided in the disclosure. The computer program product or the computer program includes computer instructions, and the computer instructions are stored in a computer-readable storage medium. For example, the computer instructions are the computer program 821. In this case, the data processing device 800 may be a computer, the processor 810 reads the computer instructions from the computer-readable storage medium 820, and executes the computer instructions, to cause the computer to perform the encoding method or decoding method provided in the various implementations. In other words, when implemented by software, all or some the above embodiments can be implemented in the form of a computer program product. The computer program product includes one or more computer instructions. When the computer instructions are loaded and executed on a computer, the procedures of embodiments of the disclosure are completely or partially run or functions of embodiments of the disclosure are completely or partially implemented. The computer may be a general-purpose computer, a special-purpose computer, a computer network, or other programmable apparatuses. The computer instructions can be stored in a computer-readable storage medium, or transmitted from one computer-readable storage medium to another computer-readable storage medium. For example, the computer instructions can be transmitted from one website, computer, server, or data center to another website, computer, server, or data center in a wired manner or in a wireless manner. Examples of the wired manner can be a coaxial cable, an optical fiber, a digital subscriber line (DSL), etc. The wireless manner can be, for example, infrared, wireless, microwave, etc.

According to another aspect of the disclosure, a bitstream is further provided in the disclosure. The bitstream may be decoded according to the decoding method provided in the disclosure or generated according to the encoding method provided in the disclosure.

Those of ordinary skill in the art will appreciate that units and process operations of various examples described in connection with embodiments of the disclosure can be implemented by electronic hardware or by a combination of computer software and electronic hardware. Whether these functions are performed by means of hardware or software depends on the application and the design constraints of the associated technical solution. Those skilled in the art can use different methods with regard to each particular application to implement the described functionality, but such implementation should not be regarded as lying beyond the scope of the disclosure.

Finally, it may be noted that, the above contents are merely embodiments of the disclosure, but are not intended to limit the protection scope of the disclosure. Any variation or substitution readily figured out by a person skilled in the art within the technical scope disclosed in the disclosure shall fall within the protection scope of the disclosure. Therefore, the protection scope of the disclosure shall be subject to the protection scope of the claims.

What is claimed is:

1. A decoding method, comprising:
determining that an intra block copy local illuminance compensation (IBC-LIC) mode is used for a current block;
determining a first prediction mode used for the current block in the IBC-LIC mode; and
performing, based on a model corresponding to the first prediction mode, illuminance compensation on a first prediction block of the current block to obtain a second prediction block of the current block, wherein the first prediction block is an intra block copy (IBC) prediction block.

2. The method of claim 1, wherein determining the first prediction mode used for the current block in the IBC-LIC mode comprises:
decoding a bitstream to determine a first index;
wherein the first index indicates the first prediction mode in at least one mode.

3. The method of claim 2, wherein the first index indicates the first prediction mode in the ordered at least one mode, and the method further comprises:
determining a distortion cost of the at least one mode, wherein a distortion cost of any mode in the at least one mode is determined based on a reconstructed sample in a template region of the current block and a sample obtained by performing illuminance compensation on at least one prediction sample using a model corresponding to the any mode, and the at least one prediction sample comprises a prediction sample obtained by predicting a sample in the template region of the current block using the IBC-LIC mode; and
obtaining the ordered at least one mode by ordering the at least one mode based on the distortion cost of the at least one mode.

4. The method of claim 2, further comprising:
determining a first model based on a reconstructed sample in a template region of the current block and a reconstructed sample in a template region of the first prediction block;
wherein the at least one mode comprises a first mode corresponding to the first model.

5. The method of claim 4, further comprising:
obtaining a second model by adjusting a parameter of the first model based on an adjustment value corresponding to the first mode;
wherein the at least one mode comprises a second mode corresponding to the second model.

6. The method of claim 2, further comprising:
determining a plurality of third models;
wherein any one of the plurality of third models is determined based on a first sample group obtained by partitioning reconstructed samples in a template region of the current block and a second sample group obtained by partitioning prediction samples in a template region of the first prediction block, and the at least one mode comprises a third mode corresponding to the plurality of third models.

7. The method of claim 6, further comprising:
obtaining a plurality of fourth models by adjusting parameters of the plurality of third models based on an adjustment value corresponding to the third mode;
wherein the at least one mode comprises a fourth mode corresponding to the plurality of fourth models.

8. The method of claim 6, further comprising:
partitioning reconstructed samples in the template region of the first prediction block into a plurality of sample groups based on values of the reconstructed samples in the template region of the first prediction block, wherein the second sample group is any one of the plurality of sample groups; and
partitioning reconstructed samples with positions corresponding to the second sample group in the template region of the current block into the first sample group.

9. The method of claim 8, wherein partitioning the reconstructed samples in the template region of the first prediction block into the plurality of sample groups based on the values of the reconstructed samples in the template region of the first prediction block comprises:
determining an average of the reconstructed samples in the template region of the first prediction block; and
partitioning the reconstructed samples in the template region of the first prediction block into the plurality of sample groups based on the average, wherein the plurality of sample groups comprise a sample group in which values of reconstructed samples are greater than or equal to the average and a sample group in which values of reconstructed samples are less than the average.

10. The method of claim 5, wherein an adjustment parameter comprises an adjustment amount of a scaling parameter and/or an adjustment amount of an offset parameter.

11. The method of claim 3, wherein the template region of the current block comprises a top template region and/or a left template region.

12. The method of claim 11, wherein a sampling step used when the template region of the current block is the top template region or the left template region is less than a sampling step used when the template region of the current block comprises the top template region and the left template region;
wherein a sample obtained in the template region of the current block according to the sampling step is used for determining a model corresponding to a mode in the at least one mode.

13. The method of claim 11, wherein:
a number of sample rows of the top template region when the template region of the current block is the top template region is greater than a number of sample rows of the top template region when the template region of the current block comprises the top template region and the left template region; and/or
a number of sample columns of the top template region when the template region of the current block is the top template region is greater than a number of sample columns of the top template region when the template region of the current block comprises the top template region and the left template region.

14. The method of claim 11, wherein:
a number of sample rows of the left template region when the template region of the current block is the left template region is greater than a number of sample rows of the left template region when the template region of the current block comprises the top template region and the left template region; and/or
a number of sample columns of the left template region when the template region of the current block is the left template region is greater than a number of sample columns of the left template region when the template region of the current block comprises the top template region and the left template region.

15. The method of claim 1, wherein determining the first prediction mode used for the current block in the IBC-LIC mode comprises:
decoding a bitstream to determine at least one index, wherein the at least one index comprises at least one of: an index indicating whether the model corresponding to the first prediction mode is a single model or a multi-model, an index indicating a template region for the model corresponding to the first prediction mode, an index indicating whether the model corresponding to the first prediction mode is a parameter-adjusted model, or an adjustment parameter corresponding to the first prediction mode; and
determining the first prediction mode based on the at least one index.

16. The method of claim 2, wherein determining whether the IBC-LIC mode is used for the current block comprises:
decoding a bitstream to determine a first flag, if the IBC mode for the current block is an IBC advanced motion vector prediction (AMVP) mode; and
determining that the IBC-LIC mode is used for the current block, if the first flag indicates that the IBC-LIC mode is enabled for the current block.

17. The method of claim 1, wherein determining whether the IBC-LIC mode is used for the current block comprises:
constructing a merge candidate list, if the IBC mode for the current block is an IBC merge mode;
determining a second index, wherein the second index indicates a block vector (BV) from the current block to a first reference block of the current block in the merge candidate list; and
determining that the IBC-LIC mode is used for the current block, if the IBC-LIC mode is used for the first reference block.

18. The method of claim 17, wherein determining the first prediction mode used for the current block in the IBC-LIC mode comprises:
determining a prediction mode for the first reference block as the first prediction mode.

19. An encoding method, comprising:
determining that an intra block copy local illuminance compensation (IBC-LIC) mode is used for a current block;
determining a first prediction mode used for the current block in the IBC-LIC mode; and
performing, based on a model corresponding to the first prediction mode, illuminance compensation on a first prediction block of the current block to obtain a second prediction block of the current block, wherein the first prediction block is an intra block copy (IBC) prediction block.

20. A non-transitory computer-readable storage medium storing computer programs and a bitstream, wherein when executed by a processor, the computer programs cause the processor to perform an encoding method to generate the bitstream, the encoding method comprising:
determining that an intra block copy local illuminance compensation (IBC-LIC) mode is used for a current block;
determining a first prediction mode used for the current block in the IBC-LIC mode; and
performing, based on a model corresponding to the first prediction mode, illuminance compensation on a first prediction block of the current block to obtain a second prediction block of the current block, wherein the first prediction block is an intra block copy (IBC) prediction block.
